(19) United States
(12) Patent Application Publication
(10) Pub. No.: US 2013/0027910 A1
(43) Pub. Date: Jan. 31, 2013

(54) LIGHTING DEVICE, DISPLAY DEVICE AND TELEVISION RECEIVER

(71) Applicant: Yasumori Kuromizu, Osaka-shi (JP)

(72) Inventor: Yasumori Kuromizu, Osaka-shi (JP)

(73) Assignee: SHARP KABUSHIKI KAISHA, Osaka (JP)

(21) Appl. No.: 13/640,567

(22) PCT Filed: Feb. 16, 2011
(86) PCT No.: PCT/JP2011/053233

§ 371 Date: Oct. 11, 2012

(30) Foreign Application Priority Data
Apr. 14, 2010 (JP) 2010-093310

(51) Int. Cl. F21V 19/00; G09F 13/04

(52) U.S. Cl. 362/97.2; 362/217.02; 362/97.1

(57) ABSTRACT

A backlight unit according to the present invention includes a chassis including a mounting through hole, a cold cathode fluorescent tube (CCFT), a diffuser plate, lamp clips that are slid along an axial direction of the CCFT when the lamp clips are mounted or detached with respect to the chassis. The lamp clips each include a main body, a light source gripping portion gripping CCFT, a support pin supporting the diffuser plate and arranged to be away from the center of the main body, and a mounting portion passed through the mounting through hole. The lamp clips are each arranged such that a distance between a reference line and the support pin is smaller than a distance between the reference line and the center of the main body. The lamp clips are arranged in adjacent first and second areas so as to be slid in opposite directions for mounting.

### TECHNICAL FIELD

The present invention relates to a lighting device, a display device, and a television receiver.

### BACKGROUND ART

A liquid crystal panel used for a liquid crystal display device such as a liquid crystal television does not emit light, and thus a backlight unit is required as a separate lighting device. The backlight unit is provided behind the liquid crystal panel (on a side opposite to a display surface). The backlight unit includes a chassis, a plurality of fluorescent tubes (for example, cold cathode fluorescent tubes), a plurality of optical members (a diffuser sheet and the like), and a plurality of lamp clips. The chassis is made of metal or resin and has an opening on a side of the liquid crystal panel. The fluorescent tubes as lamps are housed in the chassis. The optical members are provided over the opening of the chassis for efficiently introducing lights emitted by the cold cathode fluorescent tubes toward the liquid crystal panel. The lamp clips are configured to support middle portions of the cold cathode fluorescent tubes each having an elongated tubular shape.

An outer peripheral edge of the optical member is supported from a rear side by a receiving surface of the chassis and a middle portion of the optical member is supported from a rear side by a support pin provided on the lamp clip. A front side of the outer peripheral edge of the optical member is covered with a frame that supports the liquid crystal panel from the rear side. One example of the liquid crystal display device having such a configuration is disclosed in Patent Document 1.

### RELATED ART DOCUMENT

### Patent Document

Patent Document 1: Japanese Unexamined Patent Publication No. 2006-114445

### Problem to be Solved by the Invention

In the above liquid crystal display device, the outer peripheral edge of the optical member is sandwiched between the receiving surface of the chassis and the frame. In this configuration, the outer peripheral edge may be compressed. In such a case, the outer peripheral edge cannot be deformed when the optical member is subjected to a thermal expansion or thermal contraction, and thus, a middle portion of the optical member may be warped or distorted. Accordingly, the light exiting from the backlight unit may have uneven brightness.

### DISCLOSURE OF THE PRESENT INVENTION

The present invention was made in view of the above circumstances. It is an object of the present invention to provide a lighting device in which uneven brightness is less likely to occur.

### Means for Solving the Problem

A lighting device according to the present invention includes a chassis including mounting through holes, a linear light source housed in the chassis, an optical member arranged at a light exiting side of the linear light source, a plurality of light source holders configured to be slid along an axial direction of the linear light source when the light source holders are mounted or detached with respect to the chassis. The light source holders each includes a main body attached to the chassis, a light source gripping portion provided on the main body, a supporting member arranged to be away from the center of the main body, and a mounting portion protruding from the main body and configured to pass through corresponding one of the mounting through holes of the chassis such that an edge of the mounting through hole is sandwiched between the mounting portion and the main body. The light source gripping portion configured to grip the linear light source. The supporting member configured to support the optical member. The light source holders are each arranged such that a distance between a reference line in the chassis and the supporting member is smaller than a distance between the reference line and the center of the main body. The reference line is set to divide an arrangement area of the light source holders in the chassis into a first area and a second area adjacent to each other. The light source holders are each arranged in the first area and the second area so as to be slid in opposite directions when each of the light source holders is mounted in the chassis with the mounting portion passing through the mounting through hole.

With this configuration, the linear light source housed in the chassis can be gripped by the light source gripping portion of the light source holder, and the optical member arranged on the light exiting side of the linear light source can be supported by the supporting member of the light source holder. In this configuration, the light source holders attached to the chassis are arranged such that the distance between the reference line, which is set to divide an arrangement area of the light source holders in the chassis, and the supporting member, which is arranged to be away from the center of the main body, is smaller than the distance between the reference line and the center of the main body. Accordingly, a distribution density of the supporting members with respect to the inner surface of the optical member is higher at the area closer to the reference line. By setting the reference line at a position where warp and distortion of the optical member is highly likely to occur, the supporting members can properly support the optical member so that the warp and distortion is less likely to occur. Thus, the unevenness brightness is less likely to occur in the light exiting from the lighting device.

Further, in the present invention, the light source holders are configured to be slid along the axial direction of the linear light source when the light source holders are mounted or detached with respect to the chassis. With this configuration, even if the light source holder is slid too much or too less for mounting, the positional relation between the light source gripping portion and the linear light source in a direction intersecting with the axial direction of the linear light source is less likely to be changed. Accordingly, the excessive force is less likely to act on the linear light source when the linear light source is gripped by the light source gripping portion, and thus, the linear light source can be stably held. In addition, the light source holders are arranged such that the light source holders in the first area and the light source holders in the second area are slid in opposite directions when the light source holders are mounted in the chassis. This allows the light source holders with the same configuration each including the supporting member at the position away from the center of the main body to be mounted in the both areas adjacent to each other with the reference line therebetween. Accordingly, the number of kinds of the light source holder can be reduced, resulting in the reduction in cost. In addition to this, for example, in the mounting operation of the light source holders in the chassis, the mounting operation for the first area and the mounting operation for the second area can be performed by separate operators, and the operating instructions can be the same for the operators for the first and the second areas. This facilitates the mounting operation.

The following configurations are preferable as aspects of the present invention.

(1) The reference line may extend through the center of the optical member. With this configuration, the distribution density of the supporting members of the light source holders with respect to the inner surface of the optical member is higher at the area closer to the reference line. Thus, the middle portion of the optical member where the warp or distortion is highly likely to occur due to its structure can be properly supported by the supporting members.

(2) The optical member may have an elongated shape and the reference line may extend along a long-side direction of the optical member. With this configuration, the supporting members included in the light source holders are arranged such that the distribution density with respect to the inner surface of the optical member is higher at the area closer to the reference line. Thus, the supporting members can properly support the optical member along the long-side direction thereof.

(3) The light source holders may be each arranged such that the supporting member is closer to the reference line than the light source gripping portion is. With this configuration, the optical member can be supported by the supporting member that is arranged closer to the reference line than the light source gripping portion or the linear light source gripped by the light source gripping portion is. Thus, the warp or distortion of the optical member is less likely to occur.

(4) The supporting member maybe arranged on an end portion of the main body that is close to the reference line. With this configuration, the optical member can be supported by the supporting member that is arranged closest to the reference line on the light source holder. Thus, the warp or distortion of the optical member is less likely to occur.
(5) A distance between the reference line and the supporting member of at least one of the light source holders in the first area may be substantially equal to a distance between the reference line and the supporting member of at least one of the light source holders in the second area. With this configuration, the optical member can be properly supported by the supporting members.

(6) Each of the mounting through holes may include a large diameter portion having a relatively large diameter, a small diameter portion having a smaller diameter than the large diameter portion, and a connecting portion that connects the large diameter portion and the small diameter portion. An edge of the small diameter portion is sandwiched between the mounting portion and the main body. In this configuration, when the light source holder is slid with the mounting portion being passed into the large diameter portion of the mounting through hole, the mounting portion is moved into the small diameter portions through the connecting portion and the edge of each of the small diameter portions is sandwiched between the mounting portion and the main body. Accordingly, the light source holder can be stably mounted in the chassis.

(7) The mounting through holes may be each arranged such that an arrangement order of the large diameter portion and the small diameter portion in the first area is reversed in the second area. With this configuration, the light source holders in areas adjacent to each other with the reference line therebetween can be slid in opposite directions when the light source holders are mounted in the chassis.

(8) The light source holders may each further include an extended portion extending from the main body in a direction opposite to a sliding direction in which the light source holder is slid for mounting. A part of the extended portion may overlap with the large diameter portion in a plan view with the mounting portion being in the small diameter portion. In this configuration, when the light source holder is slid after the mounting portion is passed through the large diameter portion of the mounting through hole, the mounting portion enters the small diameter portion and the edge of the small diameter portion is sandwiched between the mounting portion and the main body, and further at least a part of the extended portion overlaps with the large diameter portion in a plan view. By covering the large diameter portion with the extended portion as above, the large diameter portion is not exposed. Further, the extended portion only protrudes from parts of the main body, and thus the light source holder can have a small surface area compared with the light source holder including a main body having a large width over the entire length thereof. Thus, the brightness unevenness is less likely to occur and a material cost can be reduced.

(9) The extended potion may have a width larger than the diameter of the large diameter portion. With this configuration, the extended portion can cover the entire area of the large diameter portion.

(10) Each of the light source holders may include at least three mounting portions and at least three mounting through holes. The at least three mounting portions are aligned in a direction substantially perpendicular to the axial direction of the linear light source with at least two different distances therebetween. Two of the three mounting portions arranged to sandwich a rest one of the three mounting portions are arranged asymmetrically with respect to the rest one of the three mounting portions. Further, the at least three mounting through holes are aligned in the direction substantially perpendicular to the axial direction of the linear light source with two different distances therebetween. Two of the three mounting through holes arranged to sandwich a rest one of the three mounting through holes are arranged asymmetrically with respect to the rest one of the three mounting through holes. In this configuration, if an operator tries to mount the light source holder in an orientation different from a predetermined orientation in the chassis, not all of the three mounting portions asymmetrically aligned in the direction substantially perpendicular to the axial direction of the linear light source with two different distances therebetween fit together with the corresponding mounting through holes. This does not allow the light source holder to be mounted, and then the operator realizes that the light source holder is not in the predetermined orientation. Then, the operator sets the light source holder in the predetermined orientation and begins the mounting operation again.

(11) The at least three mounting portions may be arranged on a line extending in the direction perpendicular to the axial direction of the linear light source. Further, the at least three mounting through holes may be arranged on the line extending in the direction perpendicular to the axial direction of the linear light source. With this configuration, the size of the light source holder can be made smaller in the axial direction of the linear light source.

(12) Two of the at least three mounting portions arranged on each end portion of the main body may be arranged such that a distance between the center of the main body and each of two of the at least three mounting portions is substantially equal. The light source holder can be mounted when the edges of the mounting through holes are sandwiched between the main body and the mounting portions. Accordingly, with the above configuration, the light source holder can be stably mounted in the chassis.

(13) The mounting portion may overlap with the supporting member in a plan view. With this configuration, when the mounting portions are passed through the corresponding mounting through holes, the supporting member that is arranged at a position overlapping with the one of the mounting portions can be manipulated. Thus, this operation is facilitated.

(14) The mounting portions may be concentric with the supporting member. With this configuration, when the mounting portion is passed through the corresponding mounting through hole, the supporting member concentric with the mounting portion can be manipulated. Thus, this operation is facilitated.

(15) The mounting portion may overlap with the light source gripping portion in a plan view. With this configuration, the position of the light source gripping portion can be easily recognized by visually checking the mounting portion. Conversely, the position of the mounting portion can be easily recognized by visually checking the light source gripping portion.

(16) The linear light source may include a plurality of linear light sources. The linear light sources may be spaced apart from each other with axis lines thereof being parallel to each other. Further, the light source gripping portion and the supporting member are provided adjacent to each other on each of the light source holders with a distance smaller than a distance between the adjacent linear light sources. In this configuration, the supporting member can be located between the adjacent linear light sources. Compared with the case in which the distance between the light source gripping portion and the supporting member is larger than the distance between the adjacent linear light sources, the size of the light source holder can be made smaller in the direction in which the linear light sources are arranged.

(17) Each of the light source holders include a plurality of light source gripping portions. The light source gripping portions may be adjacent to each other. Further, the supporting member may be arranged adjacent to one of the light source gripping portions. A distance between the supporting member and the light source gripping portion adjacent to the supporting member may be smaller than a distance between the adjacent light source gripping portions. In this configuration, the supporting member can be located between the adjacent linear light sources gripped by the adjacent light source gripping portions. Compared with the case in which a distance between the light source gripping portion and the supporting member is larger than a distance between the adjacent light source gripping portions, the size of the light source holder can be made smaller in the direction in which the light source gripping portions are arranged.

(18) The light source gripping portions of each light source holder may be substantially aligned in the direction substantially perpendicular to the axial direction of the linear light source. With this configuration, the linear light sources can be gripped by the light source gripping portions at substantially the same position in the axial direction of the linear light source. Thus, the linear light sources can be stably held.

(19) The supporting member and the light source gripping portion may be substantially aligned in the direction substantially perpendicular to the axial direction of the linear light source. With this configuration, the size of the light source holder can be made smaller in the axial direction of the linear light source.

(20) A distance between the center of the main body and one of the light source gripping portion and the supporting member on one end portion of the main body may be substantially equal to a distance between the center of the main body and one of the light source gripping portion and the supporting member on the other end of the main body. With this configuration, any of the light source gripping portion and the supporting member on each end portion of the main body can properly perform its function.

(21) The linear light source may include a plurality of linear light sources. The linear light sources may be substantially equally spaced apart from each other with axis lines thereof being parallel to each other. With this configuration, uneven brightness is less likely to occur in the light exiting from the lighting device.

(22) The light source holders may be arranged in the chassis in a zigzag pattern. With this configuration, the light source holder arranged in the chassis is less likely to be recognized as a dark portion, and thus brightness unevenness is less likely to occur.

(23) The linear light source may be a cold cathode fluorescent tube. With this configuration, a service life of the light source can be longer and control of light can be easily performed.

Next, to solve the above problem, a display device according to the present invention may include the above-described lighting device and a display panel configured to provide display using light from the lighting device.

According to such a display device, the uneven brightness is less likely to occur in the lighting device that is configured to provide light to the display panel. Thus, high display quality can be obtained.

The display panel may be a liquid crystal panel. The display device as a liquid crystal display device has a variety of applications, such as a television display or a personal-computer display. Particularly, it is suitable for a large screen display.

### Advantageous Effect of the Invention

According to the present invention, the uneven brightness is less likely to occur.

### BRIEF DESCRIPTION OF THE DRAWINGS

FIG. 1 is an exploded perspective view of a general construction of a television receiver according to the first embodiment of the present invention;

FIG. 2 is an exploded perspective view illustrating a general configuration of a liquid crystal display device;

FIG. 3 is a cross-sectional view of the liquid crystal display device taken along a short-side direction thereof;

FIG. 4 is a cross-sectional view of the liquid crystal display device taken along a long-side direction thereof;

FIG. 5 is a plan view of a lamp clip;

FIG. 6 is a bottom view of the lamp clip;

FIG. 7 is a plan view illustrating a state in which the lamp clips are mounted in the chassis;

FIG. 8 is a plan view of the chassis;

FIG. 9 is a magnified plan view of mounting through holes of the chassis;

FIG. 10 is a cross-sectional view illustrating a state in which the lamp clip is mounted in the liquid crystal display device;

FIG. 11 is a plan view illustrating a state in which the mounting portions of the lamp clip in a first state fit together with the corresponding mounting through holes;

FIG. 12 is a plan view illustrating a state in which the lamp clip in the first state is slid for mounting;

FIG. 13 is a plan view illustrating a state in which the mounting portions of the lamp clip in a second state do not fit together with the corresponding mounting through holes,

FIG. 14 is a cross-sectional view taken along a line xiv-xiv in FIG. 13; and

FIG. 15 is a plan view of the lamp clip according to an embodiment (1) of the other embodiments.

### BEST MODE FOR CARRYING OUT THE INVENTION

### First Embodiment

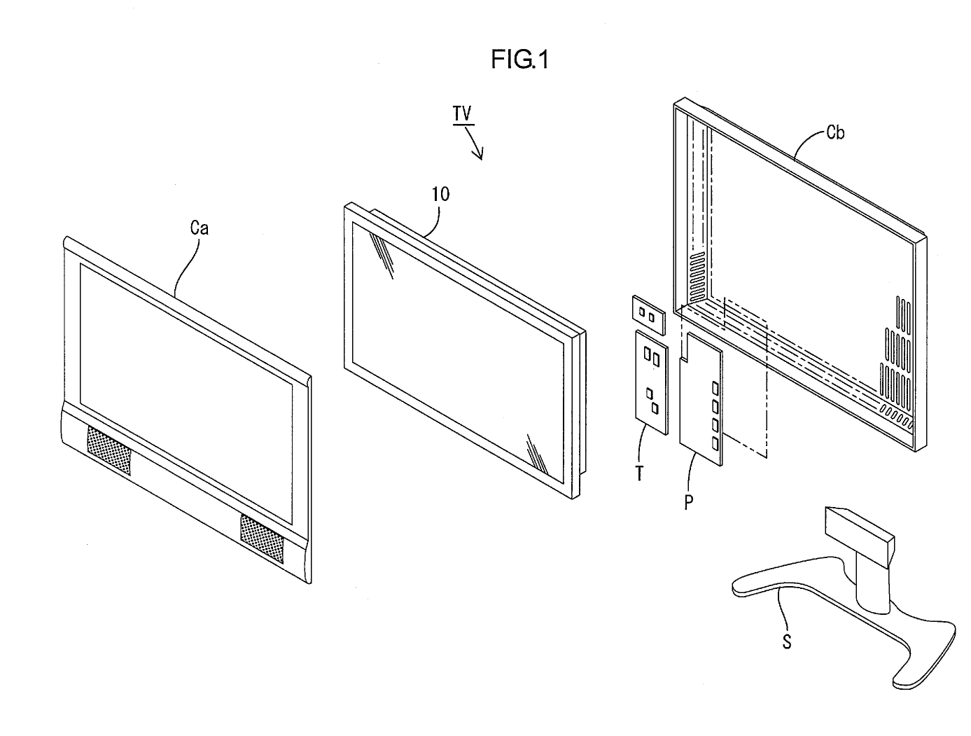

The first embodiment of the present invention will be described with reference to FIG. 1 to FIG. 14.

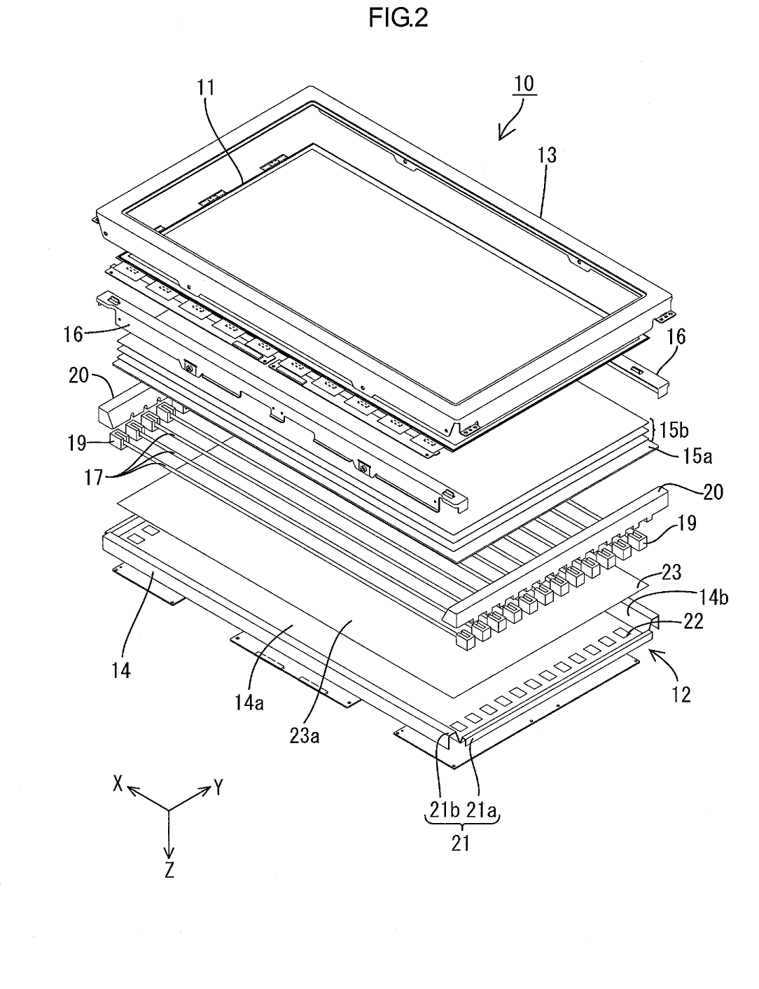

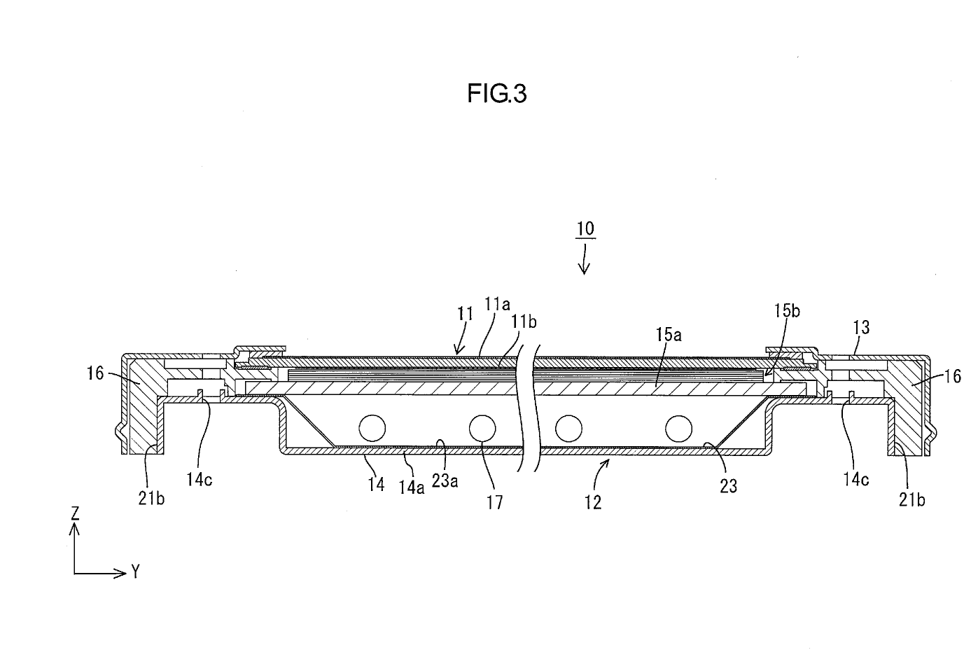

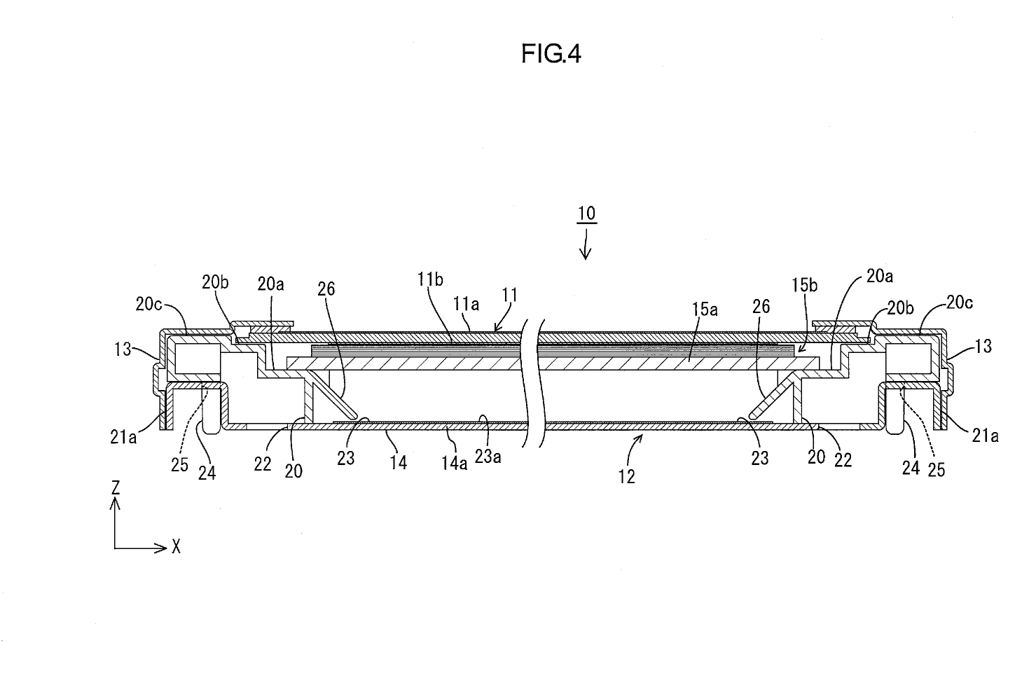

As illustrated in FIG. 1, the television receiver TV of the present embodiment includes the liquid crystal display device 10, front and rear cabinets Ca, Cb which house the liquid crystal display device 10 therebetween, a power source P, a tuner T and a stand S. An entire shape of the liquid crystal display device (a display device) 10 is a landscape rectangular shape (an elongated shape). The liquid crystal display device 10 is housed in a vertical position. As illustrated in FIG. 2, the liquid crystal display device 10 includes a liquid crystal panel 11 as a display panel, and a backlight unit (a lighting device) 12 as an external light source. The liquid crystal panel 11 and the backlight unit 12 are integrally held by a frame shaped bezel 13 and the like. An X-axis, a Y-axis and a Z-axis are described in a part of the drawings, and a direction of each axial direction corresponds to a direction described in each drawing. An upper side in FIG. 3 and FIG. 4 corresponds to a front-surface side and a lower side in FIG. 3 and FIG. 4 corresponds to a rear-surface side.

Next, the liquid crystal panel 11 and the backlight unit 12 included in the liquid crystal display device 10 will be sequentially explained (see, FIG. 2 to FIG. 4). The liquid crystal panel (a display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrodes, an alignment film, and the like are provided. Polarizing plates 11a, 11b are arranged on outer surfaces of the substrates (see, FIG. 3 and FIG. 4).

As illustrated in FIG. 2, the backlight unit 12 includes a chassis 14, a diffuser plate 15a, and optical sheets 15b, and a frame 16. The chassis 14 has a substantially box-shape and has an opening 14b on the light exit side (the front side, the liquid crystal panel 11 side). The optical sheets 15b are provided so as to cover the opening 14b of the chassis 14. The frame 16 provided along a long side of the chassis 14 holds a long-side edge of the optical sheets 15a such that the edge is sandwiched between the frame 16 and the chassis 14. The optical sheets 15b are provided between the diffuser plate 15a and the liquid crystal panel 11. The chassis 14 houses cold cathode fluorescent tubes (linear light sources) 17, lamp clips 18 for mounting the cold cathode fluorescent tubes 17 in the chassis 14, relay connectors 19 that relay electrical connection at ends of the respective cold cathode fluorescent tubes 17, and a holder 20 that collectively covers the ends of the cold cathode fluorescent tubes 17 and the relay connectors 19. In the backlight unit 12, the light exit side is the side closer to the diffusing plate 15a than the cold cathode fluorescent tube 17. The lamp clips 18 are not shown in FIG. 2 to FIG. 4.

The chassis 14 is made of metal. A metal sheet is formed into a shallow substantially box shape including a rectangular bottom plate 14a and a folded outer rim portion 21 (including short-side folded outer rims 21a and long-side folded outer rims 21b) that rise from respective sides of the bottom plate and formed into a substantially U-shape. The bottom plate 14a of the chassis 14 has a plurality of mounting through holes 22 for mounting the relay connectors 19. The mounting through holes 22 are provided in areas near long-side ends of the bottom plate 14a. Further, in an upper surface of the folded outer rim 21b of the chassis 14, as illustrated in FIG. 3, fixing holes 14c are provided so that the bezel 13, the frame 16, and the chassis 14 or the like can be integrated by a screw or the like.

A reflection sheet 23 is provided on an inner surface of the bottom plate 14a of the chassis 14 (a surface facing the cold cathode fluorescent tube 17) so as to extend along the inner surface of the bottom plate 14 and cover substantially the entire of the inner surface. The reflection sheet 23 is made of synthetic resin and has a surface having white color that provides high light reflectivity. As illustrated in FIG. 3, long-side edge portions of the reflection sheet 23 rise so as to cover the folded outer rims 21b of the chassis 14 and are held between the chassis 14 and the diffuser plate 15a. The reflection sheet 23 can reflect light emitted from the cold cathode fluorescent tube 17 toward the diffuser plate 15a.

The cold cathode fluorescent tube 17 is a kind of linear light source (tubular light source). As illustrated in FIG. 2 and FIG. 3, the cold cathode fluorescent tubes 17 are housed in the chassis 14 such that the axial direction thereof matches the long-side direction (the X-axis direction) of the chassis 14. The cold cathode fluorescent tubes 17 are arranged along the short-side direction (the Y-axis direction) of the chassis 14 such that the axis lines thereof are substantially parallel to each other with a predetermined distance therebetween. That is, the cold cathode fluorescent tubes 17 are spaced apart from each other. The distances between the cold cathode fluorescent tubes 17, i.e., an arrangement pitch, are substantially the same. The cold cathode fluorescent tube 17 is arranged slightly above the bottom plate 14a of the chassis 14 (the reflection sheet 23), and ends thereof are fitted in the relay connector 19. The holder 20 is mounted so as to cover the relay connectors 19. In FIG. 4, the cold cathode fluorescent tube 17 is not illustrated.

The holder 20 is made of synthetic resin having white color. The holder 20 has an elongated box-like shape extending along the short-side direction of the chassis 14 and covers the end portions of the cold cathode fluorescent tubes 17. As illustrated in FIG. 4, the holder 20 has a stepped surface on which the diffuser plate 15a and the liquid crystal panel 11 can be placed at different levels. A part of the holder 20 overlaps with the short-side folded outer rim 21a of the chassis 14 such that the part of the holder 20 and the short-side folded outer rim 21a form a side wall of the backlight unit 12. From a surface of the holder 20 which faces the short-side folded outer rim 21a of the chassis 14, an insertion pin 24 protrudes. The holder 20 is mounted in the chassis 14 by inserting the insertion pin 24 into an insertion hole 25 provided in an upper surface of the short-side folded outer rim 21a.

The stepped surface of the holder 20 has three steps 20a, 20b, and 20c parallel to the surface of the bottom plate 14a of the chassis 14. On the first step 20a that is the lowest step, the short-side edge potion of the diffuser plate 15a is placed. Further, from the first step 20a, a sloping cover 26 sloping toward the inner surface of the bottom plate 14a of the chassis 14 extends. On the second step 20b of the stepped surface of the holder 20, the short-side edge portion of the liquid crystal panel 11 is placed. The third step 20c that is the highest step of the stepped surface of the holder 20 overlaps with the folded outer rim 21a of the chassis 14 and is in contact with the bezel 13.

The diffuser plate 15a includes a plate member made of synthetic resin and light scattering particles dispersed therein. The diffuser plate 15a has a function for diffusing linear light emitted from the cold cathode fluorescent tube 17 as the linear light source. As described above, the short-side edge portion of the diffuser plate 15a is placed on the first step 20a of the holder 20 and is not restrained in the vertical direction. As illustrated in FIG. 3, the long-side edge portion of the diffuser plate 15a is sandwiched between the chassis 14 (the reflection sheet 23) and the frame 16 so that the long-side edge portion of the diffuser plate 15a is fixed.

The optical sheets 15b arranged on the diffuser plate 15a include, a diffuser sheet, a lens sheet, and a reflection-type polarizing plate in this sequence from the diffuser plate 15a side. The optical sheets 15b are configured to convert the light passed through the diffuser plate 15a into planar light. The liquid crystal panel 11 is provided on the front side of the optical sheets 15b. The optical sheets 15b are provided between the diffuser plate 15a and the liquid crystal panel 11. The diffuser plate 15a and the optical sheets 15b as the optical member each have an elongated shape and the long-side direction and the short-side direction thereof match the long-side direction and the short-side direction of the bottom plate 14a of the chassis 14, respectively (FIG. 2).

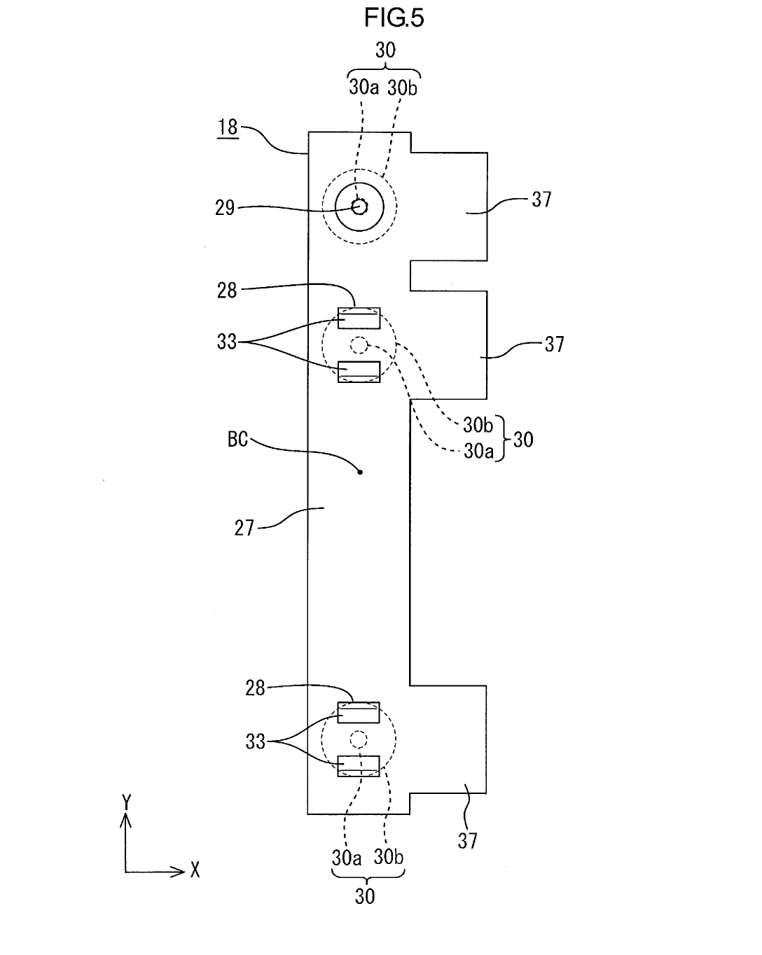

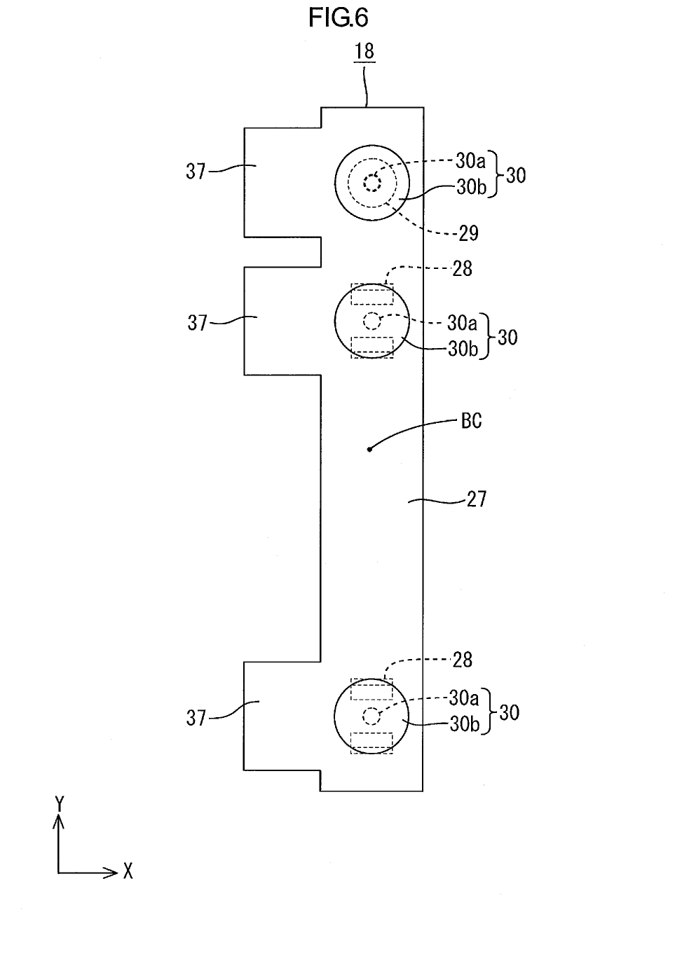

Here, the lamp clip 18 will be described in detail. The lamp clip 18 is made of synthetic resin (for example, polycarbonate), and has a surface having white color that provides high light reflectivity. As illustrated in FIG. 5 and FIG. 6, the lamp clip 18 includes a main body 27 (a mounting plate) that has substantially a plate shape extending along the bottom plate 14a of the chassis 14 (the reflection sheet 23). The main body 17 has a vertically rectangular shape (an elongated shape) in a plan view. The lamp clip 18 is mounted in the chassis 14 such that the longitudinal direction (the long-side direction) of the main body 27 matches the Y-axis direction and the width direction (the short-side direction) of the main body 27 matches the X-axis direction. In other words, the lamp clip 18 is mounted in the chassis 14 such that the long-side direction of the main body 27 is substantially parallel with the short-side direction of the chassis 14 and the width direction of the main body 27 is substantially parallel with the long-side direction of the chassis 14. The lamp clip 18 is mounted in the chassis 14 in an orientation or in a state such that the longitudinal direction of the main body 27 is substantially parallel with the direction (the Y-axis direction) that is perpendicular to the axial direction (the X-axis direction) of the cold cathode fluorescent tube 17 and the width direction of the main body 27 is substantially parallel with the axial direction of the cold cathode fluorescent tube 17.

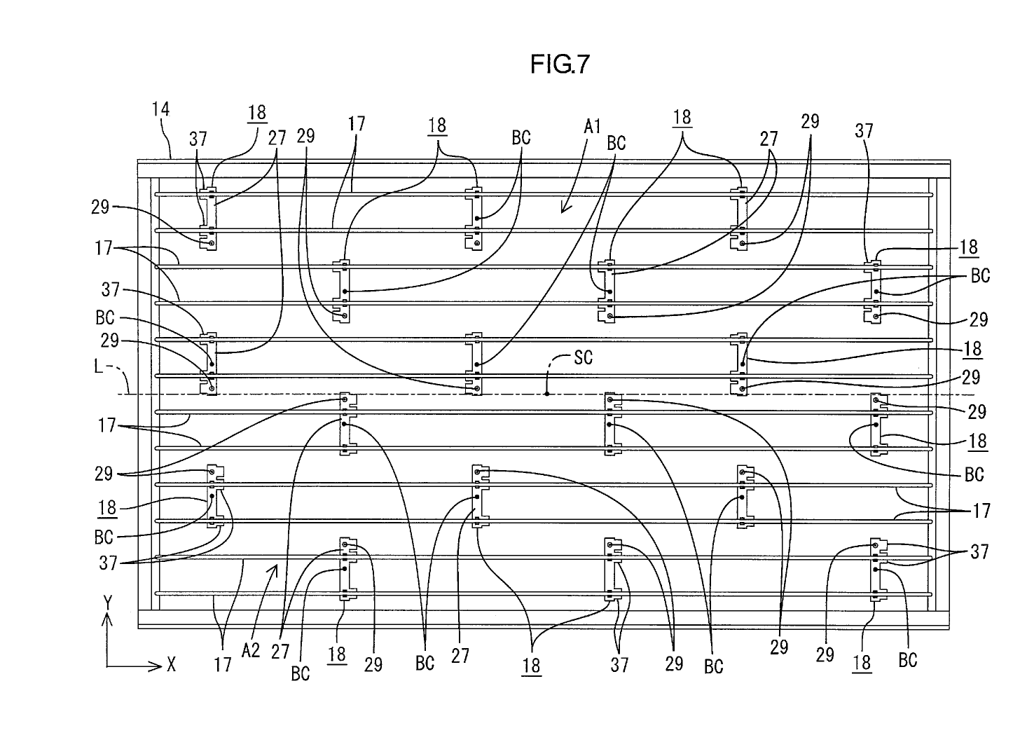

As illustrated in FIG. 7, the lamp clips 18 are arranged in the chassis 14 in a dispersed manner. The positions of the lamp clips 18 will be described in detail below. A total of 18 lamp clips 18 are arranged on the bottom plate 14a of the chassis 14 in a zigzag pattern (a grid pattern, a staggered pattern). Three lamp clips 18 are arranged in the X-axis direction (the long-side direction of the chassis 14) and six lamp clips 18 are arranged in the Y-axis direction (the short-side direction of the chassis 14). The three lamp clips 18 arranged in the X-axis direction are linearly arranged with a predetermined distance therebetween in the X-axis direction. Thus, the cold cathode fluorescent tubes 17 can be gripped at three positions that are spaced apart from each other in the axial direction. The three lamp clips 18 linearly arranged in the X-axis direction are substantially equally spaced apart from each other. The three lamp clips 18 are linearly arranged on one line extending in the X-axis direction. The lamp clips 18 on a next line in the Y-axis direction are arranged so as not to be directly adjacent to the lamp clips 18 on the one line. Each lamp clip 18 on the next line is arranged at substantially the middle of two of the lamp clips 18 on the one line. With this arrangement, the lamp clips 18 are arranged away from each other in the X-axis and Y-axis directions. Accordingly, even if the lamp clip 18 has a surface having light reflectivity different from that of the reflection sheet 23, namely lower reflectivity, the lamp clip 18 is less likely to be recognized as dark portions, and thus brightness unevenness is less likely to occur.

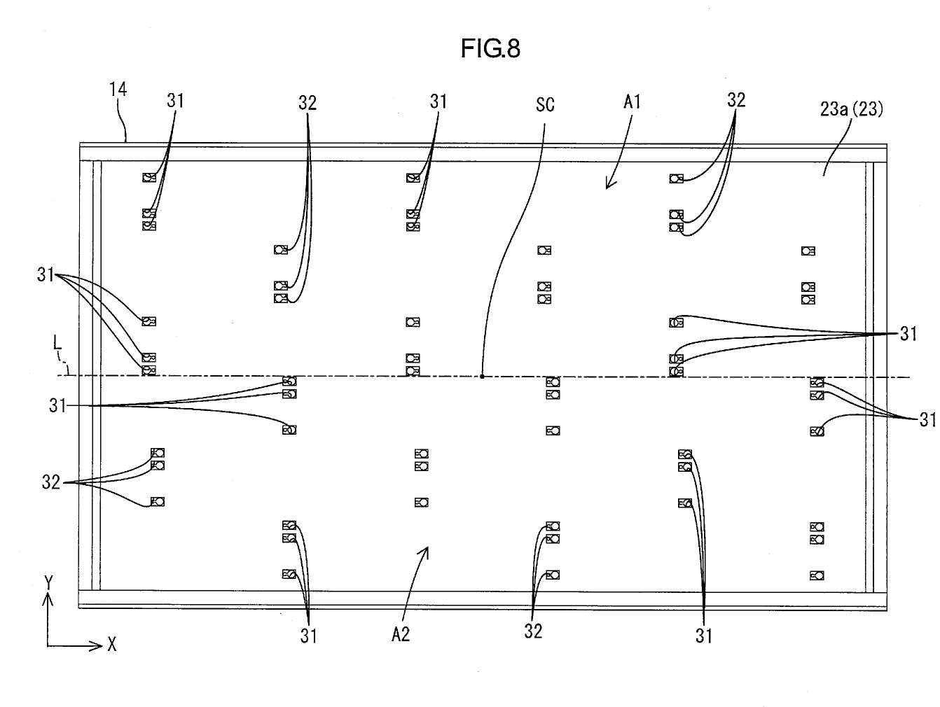

As illustrated in FIG. 8, a set of three mounting through holes 31 and a set of three insertion holes 32 extend through the bottom plates 14a, 23a of the chassis 14 and the reflection sheet 23, respectively, in the thickness direction thereof. Mounting portions 30 which will be described later are passed through the mounting through holes 31 and the insertion holes 32 to mount the lamp clip 18. The mounting portions 30, the mounting through holes 31, and the insertion holes 32 will be described in detail later.

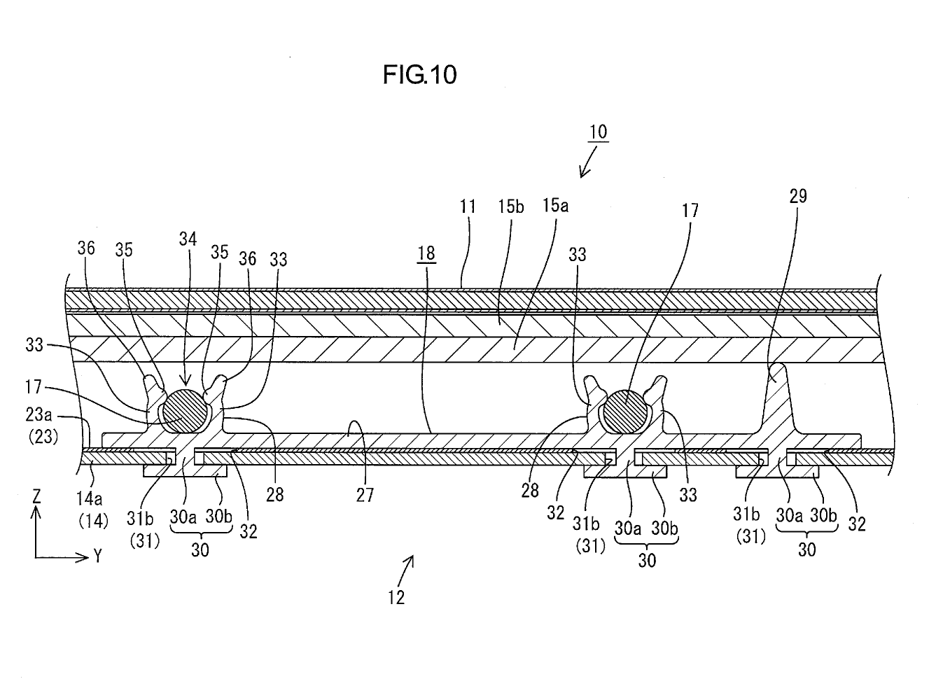

Next, a detail configuration of the lamp clip 18 will be described. As illustrated in FIG. 5 and FIG. 10, the main body 27 included in the lamp clip 18 includes two lamp gripping portion 28 and one support pin 29 on a front surface (a surface facing the diffuser plate 15a and the cold cathode fluorescent tube 17, a surface opposite to the chassis 14 side). The lamp gripping portion 28 is configured to support the cold cathode fluorescent tube 17 at a predetermined height position. The support pin 29 is configured to support the diffuser plate 15a at a position higher than the cold cathode fluorescent tube 17 (at a position closer to the light exit side).

The arrangement of the lamp gripping portion 28 and the support pin 29 will be described in detail. As illustrated in FIG. 5, two lamp gripping portions 28 are arranged adjacent to each other on the main body 27 with a predetermined distance therebetween in the longitudinal direction (the Y-axis direction) of the main body 27. Each of the two lamp gripping portions 29 is configured to grip a separate cold cathode fluorescent tube 17. The space between the two lamp gripping portions 28 is substantially the same as the space between the cold cathode fluorescent tubes 17 arranged in the chassis 14. One of the lamp gripping portions 28 is arranged near the center of the main body 27 in the Y-axis direction and the other one of the lamp gripping portions 27 is arranged near one end of the main body 27 (near a lower-side end in FIG. 5). The two lamp gripping portions 28 are away from the center point BC of the main body 27 in the Y-axis direction, that is, located at eccentric positions. The lamp gripping portion 28 near the center is relatively close to the center point BC of the main body 27 and the lamp gripping portion 28 on the one end of the main body 27 is relatively away from the center point BC. The two lamp gripping portions 28 are aligned in the direction substantially perpendicular to the X-axis direction. The two lamp gripping portions 28 are arranged on substantially the middle portion of the main body 27 in the width direction (the short-side direction, the X-axis direction). The support pin 29 is arranged near the other end of the main body 27 in the Y-axis direction. That is, the support pin 29 is arranged near the end (near an upper end in FIG. 5) opposite to the one end of the main body 27 near which the lamp gripping portion 28 is arranged. The support pin 29 is arranged such that a distance between the center point BC of the main body 27 and the support pin 29 is substantially the same as a distance between the center point BC and the lamp gripping portion 28 near the one end of the main body 27. That is, the support pin 29 and the lamp gripping portion 28 near each end of the main body 27 are symmetrically arranged with respect to the center point BC of the main body 27. A distance between the support pin 29 and the lamp gripping portion 28 near the center of the main body 27 in the Y-axis direction is smaller than a distance between the adjacent lamp gripping portions 28 (a distance between the adjacent cold cathode fluorescent tubes 17). Specifically, the former distance is about the half of the latter distance. The position of the support pin 29 in the X-axis direction is substantially the same as the position of the lamp gripping portion 28 in the X-axis direction. Accordingly, the two lamp gripping portions 28 and the support pin 29 are linearly arranged along the Y-axis direction with each predetermined distance therebetween.

The configuration of the lamp gripping portion 28 will be described in detail. As illustrated in FIG. 10, the lamp gripping portion 28 supports a middle portion of the cold cathode fluorescent tube 17 between ends thereof to which electrodes are provided. Namely, a light emitting portion of the cold cathode fluorescent tube 17 is supported by the lamp gripping portion 28 from a back side at a position slightly above the reflection sheet 23. The lamp gripping portion 28 has an open-end ring overall shape opening toward the front side. The lamp gripping portion 28 has a pair of arm portions 33 facing each other. Between tip portions of the arm portions 33, there is an opening 36 through which the cold cathode fluorescent tube 17 can pass to be attached or detached along the Z-axis direction (the thickness direction of the chassis 14 and the bottom plate 14a, 23a of the reflection sheet 23). The arm portions 33 are cantilevered to rise from the front surface of the main body 27 at positions spaced apart in the longitudinal direction (the Y-axis direction), and curved into a substantially arc shape. A curvature of the arm portion 33 substantially matches a curvature of an outer peripheral surface of the cold cathode fluorescent tube 17 to be mounted. A gap width between each arm portion 33 and the cold cathode fluorescent tube 17 is substantially constant in a circumferential direction in a state that the cold cathode fluorescent tube 17 is mounted. The arm portions 33 have a symmetrical shape with respect to an axis of symmetry that extends along the Z-axis direction and passes through the middle of the lamp gripping portions 28 in the Y-axis direction. The arm portions 33 are elastically deformable in the width direction with a base end rising from the main body 27 as a fulcrum. The pair of arm portions 33 has a width smaller than the width of the main body 27.

On inner surfaces (surfaces facing the cold cathode fluorescent tube 17) of tip portions of the arm portions 33, holding protrusions 35 for holding the cold cathode fluorescent tube 17 in place are provided. The above-described opening 34 is present between the holding protrusions 35. A width of the opening 34 is slightly smaller than the outer diameter of the cold cathode fluorescent tube 17. Thus, when the cold cathode fluorescent tube 17 is attached or detached through the opening 34, the arm portions 33 are pressed by the cold cathode fluorescent tube 17 and elastically expanded and deformed. The holding protrusions 35 protrude inward from the inner surfaces of the tip portions of the arm portions 33 (toward the central axis line of the cold cathode fluorescent tube 17), and are located on the front side (the light exit side) of the cold cathode fluorescent tube 17, that is, the side to which the cold cathode fluorescent tube 17 is removed. The cold cathode fluorescent tube 17 mounted on the lamp gripping portion 28 is supported at three points. The first support point is a point on the bottom surface of the lamp gripping portion 28 directly below the middle of the cold cathode fluorescent tube 17. The second support point and the third support point are points on inner ends of the holding protrusions 35. Between the adjacent support points, a slight gap (clearance) extending circumferentially between the outer peripheral surface of the cold cathode fluorescent tube 17 and the inner surface of the lamp gripping portion 28 is present.

On outer surfaces of the tip portions of the arm portions 33, guide portions 36 for guiding the mounting operation of the cold cathode fluorescent tube 17 are provided. The guide portions 38 rise obliquely outward from the arm portions 33 and are tapered. The guide portions 36 are spaced apart from each other as each guide portion 36 slopes from a base end toward a tip. Inner surfaces of the guide portions 36 facing the cold cathode fluorescent tube 17 are sloped in the same manner. Thus, the space between the inner surfaces of the guide portions 36 facing each other gradually decreases toward the lower side in FIG. 10, that is, toward the side to which the cold cathode fluorescent tube 17 is attached, while gradually increases toward the side to which the cold cathode fluorescent tube 17 is removed. Thus, the mounting operation of the cold cathode fluorescent tube 17 can be smoothly guided by the inner surfaces of the guide portions 36. The inner surfaces of the guide portions 36 are gently connected to the inner surfaces of the holding protrusions 35.

Next, the configuration of the support pin 29 will be described in detail. As illustrated in FIG. 10, the support pin 29 supports the diffuser plate 15a from a back side thereof at a middle position rather than an outer peripheral portion supported by the holder 20 or the like. Thus, the diffuser plate 15a is less likely to be bent or warped toward the cold cathode fluorescent tube 17. The support pin 29 has a circular sectional shape when cut along a horizontal direction (FIG. 5), and has a tapered shape having a gradually decreasing diameter from a root toward a tip. In other words, the support pin 29 has a substantially conical shape. A tip portion of the support pin 29 that can be in abutting contact with the diffuser plate 15a is rounded to be a rounded surface. A height of the support pin 29 from the main body 27 is set to be higher than that of the lamp gripping portion 28. Accordingly, an operator can perform an attachment or detachment of the lamp clip 18 with respect to the chassis 14 by gripping the support pin 29. Thus, the support pin 29 can also function as an operation member for the attachment and the detachment.

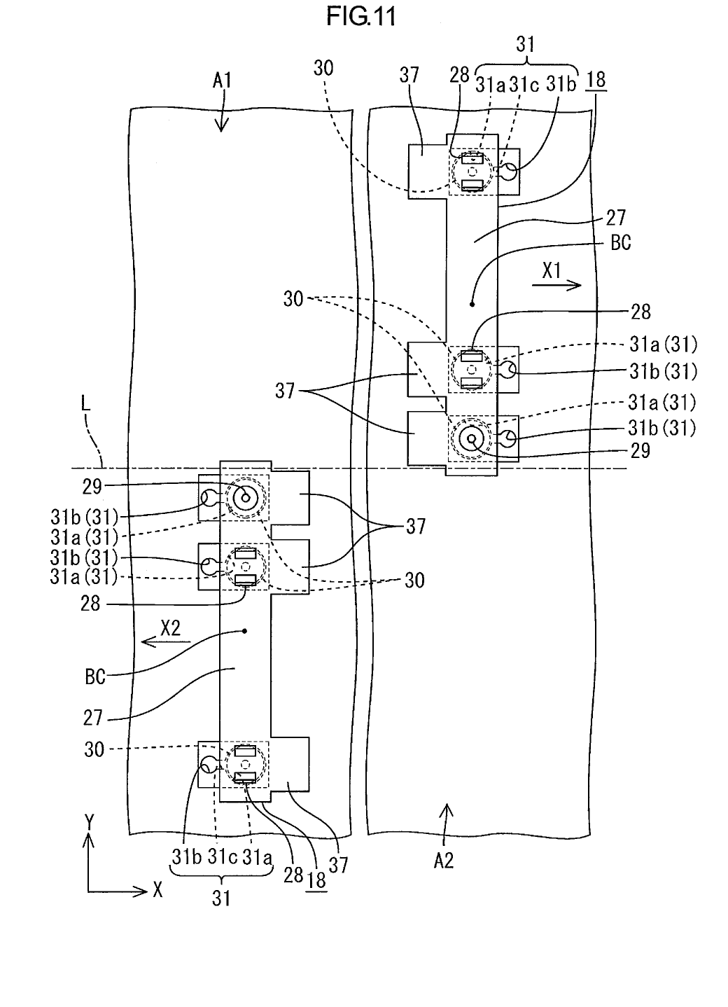

Next, the mounting configuration (holding configuration) of the lamp clip 18 with respect to the chassis 14 will be described in detail. On a rear surface of the main body 27 (a surface facing the chassis 14 and the reflection sheet 23, a surface on a side opposite to the diffuser plate 15a and the cold cathode fluorescent tube 17 side), the total of three mounting portions 30 are provided. The mounting portions 30 are configured to maintain the mounting state of the lamp clip 18 in the chassis 14. In order to mount the lamp clip 18 in the chassis 14, the mounting portions 30 are passed through the mounting through holes 31 of the chassis 14, and then the lamp clip 18 is slid in the X-axis direction, i.e., the axial direction of the cold cathode fluorescent tube 17. Consequently, the edges of the mounting through holes 31 are sandwiched between the mounting portions 30 and the main body 27. Thus, the lamp clip 18 is mounted in the chassis 14. Hereinafter, a sliding direction in which the lamp clip 18 is slid for mounting is referred to as a front direction (directions indicated by arrows in FIG. 11), a sliding direction in which the lamp clip 18 is slid for detaching is referred to as a back direction (directions opposite to the directions indicated by the arrows in FIG. 11).

The mounting portions 30 are separately arranged in a long-side direction of the main body 27. As illustrated in FIG. 5, FIG. 6, and FIG. 10, the mounting portions 30 each include a base portion 30a and a protrusion 30b. The base portion 30a protrudes from the rear surface of the main body 27 in the Z-axis direction to the rear side (the chassis 14 side). The protrusion 30b protrudes from an end of the base portion 30a in the X-axis and Y-axis directions (the direction along the main body 27). The base portion 30a has a circular cross-sectional shape and has a constant diameter over the entire length thereof. In other words, the base portion 30a has a cylindrical shape. The protrusion 30b has a flange like shape (a brim like shape) that extends radially from the end of the base portion 30a. The protrusion 30b has a circular shape in a plan view and has a larger diameter than that of the base portion 30a. The protrusion 30b is arranged concentrically with the base portion 30a.

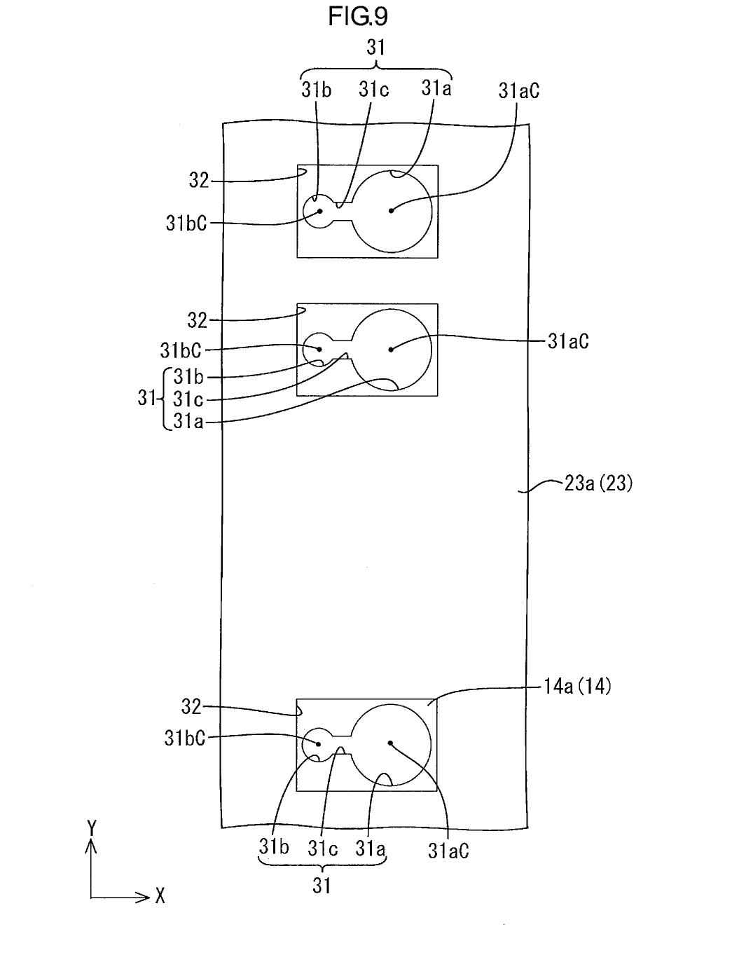

As illustrated in FIG. 9, the mounting through holes 31 provided in the chassis 14 each include a large diameter portion 31a having a relatively large diameter, a small diameter portion 31b having a smaller diameter than the large diameter portion 31a and spaced apart from the large diameter potion 31a, and a connecting portion 31c arranged so as to connect the large diameter portion 31a and the small diameter portion 31b. The large diameter portions 31a and the small diameter portion 31b each have a circular shape in a plan view. The connecting portion 31c connecting the large diameter portion 31a and the small diameter portion 31b extends straightly with a constant width in a plan view. The large diameter portion 31a has a diameter larger than that of the protrusion 30b of the mounting portion 30. Thus, the protrusion 30b, i.e., the mounting portion 30 can be passed through the large diameter portion 31a. On the other hand, the small diameter portion 31b has a diameter larger than that of the base portion 30a of the mounting portion 30, but smaller than that of the protrusion 30b. Thus, the protrusion 30b cannot be passed through the small diameter portion 31b.

The large diameter portion 31a and the small diameter portion 31b are arranged along the X-axis direction (the longitudinal direction of the cold cathode fluorescent tube 17, the short-side direction of the main body 27). In other words, the large diameter portion 31a and the small diameter portion 31b are arranged such that a line connecting the center 31aC of the large diameter portion 31a and the center 31bC of the small diameter portion 31b are substantially parallel with the X-axis direction. The distance between the center 31aC of the large diameter portion 31a and the center 31bC of the small diameter portion 31b is equal to the sliding distance in which the lamp clip 18 is slid for mounting. The small diameter portion 31b is arranged on the front side of the large diameter portion 31a (the left side in FIG. 9, the sliding direction for mounting the lamp clip 18) with a predetermined distance from the large diameter portion 31a. The connecting portion 31c has a width larger than diameter of the base portion 30a of the mounting portion 30, but smaller than the diameter of the small diameter portion 31b. With this configuration, the base portion 30a can move between the large diameter portion 31a and the small diameter portion 31b through the connecting portion 31c. The center in the width direction of the connecting portion 31c is on the line connecting the center 31aC of the large diameter portion 31a and the center 31bC of the small diameter portion 31b.

As illustrated in FIG. 8 and FIG. 9, the insertion holes 32 are arranged in the reflection sheet 23 so as to overlap with the mounting through holes 31 in a plan view when the reflection sheet 23 is arranged in the chassis 14. The insertion holes 32 each have a landscape rectangular shape in a plan view. The insertion hole 32 has a short side larger than the diameter of the large diameter portion 31a and a long side larger than the total of the diameters of the large diameter portion 31a and the small diameter portion 31b and the length of the communicating portion 31c. The insertion holes 32 are slightly larger than the mounting through holes 31. The mounting through holes 31 and the corresponding insertion holes 32 may have a position gap when the reflection sheet 23 is mounted in the chassis 14. The difference in size between the mounting through holes 31 and the insertion holes 32 is set so as to be equal to or larger than the largest possible value of the position gap. Accordingly, the mounting through holes 31 can be properly arranged in the respective insertion holes 32, and thus the mounting through holes 31 are not covered with the reflection sheet 23.

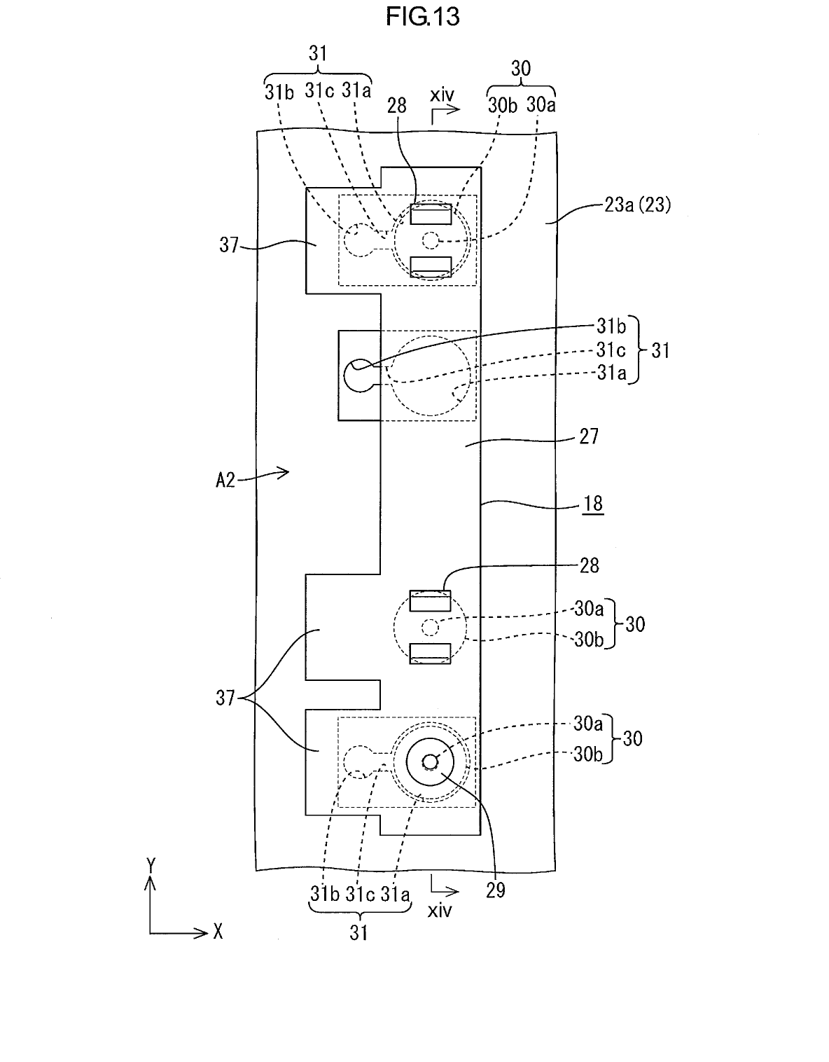

Here, the arrangement of three mounting portions 30 and the mounting through holes 31 with respect to one lamp clip 18 will be explained in detail. The mounting portions 30 and the mounting through holes 31 are arranged in a positional relation that can prevent the lamp clip 18 from being mounted in the chassis 14 in an orientation that is not the predetermined orientation. Specifically, when the lamp clip 18 is mounted in the chassis 14, the main body 27 is set along the bottom plate 14a of the chassis 14 and the long-side direction of the main body 27 is set along (coincidence with) the short-side direction of the chassis 14. However, the lamp clip 18 may be rotated 180 degrees around a predetermined point. Namely, the lamp clip 18 may be arranged in two different orientations. If the lamp clip 18 is arranged in a first orientation of the two different orientations (in one orientation that is illustrated in FIG. 11), the mounting portions 30 fit together with the corresponding mounting through holes 31. However, if the lamp clip 18 is arranged in a second orientation (in the other orientation that is illustrated in FIG. 13), the mounting portions 30 do not fit together with the corresponding mounting through holes 31. Hereinafter, the specific construction will be described in details.

As illustrated in FIG. 5 and FIG. 6, the three mounting portions 30 are spaced apart from each other in the Y-axis direction on the main body 27. One of the three mounting portions 30 is arranged near the center in the Y-axis direction and the other two of the three mounting portions 30 are arranged near each end in the Y-axis direction, that is, the three mounting portions 30 are arranged to be away from the center of the main body 27. The two mounting portions 30 near each end of the main body 27 are arranged on each end portion of the main body 27 in the longitudinal direction (the long-side direction) such that the two mounting portions 30 are substantially equally spaced apart from the center point BC of the main body 27. That is, the two mounting portions 30 are symmetrically arranged. The mounting portion 30 near the center of the main body 27 is unequally spaced apart from each mounting portion 30 near each end of the main body 27. Specifically, the mounting portion 30 near the center of the main body 27 is arranged relatively far from the mounting portion 30 near the one end of the main body 27 (the lower-side end in FIG. 5 and FIG. 6) and relatively close to the mounting portion 30 near the other end of the main body 27 (the upper-side end in FIG. 5 and FIG. 6). The three mounting portions 30 are arranged at substantially the same position in the X-axis direction that is substantially the center of the main body 27 in the width direction (the short-side direction, the X-axis direction). The mounting portion 30 near the center of the main body 27 and the mounting portion 30 near the one end of the main body 27 overlap with the lamp gripping portions 28 on the front surface in a plan view. The mounting portion 30 near the other end of the main body 27 is concentric with the support pin 29 on the front surface in a plan view. As illustrated in FIG. 9, the three mounting through holes 31 are aligned in the Y-axis direction in the bottom plate 14a of the chassis 14. The mounting through holes 31 near each end of the main body 27 are unequally spaced apart from the mounting through hole 31 near the center of the main body 27. Specifically, the mounting through hole 31 near the center is arranged relatively close to the mounting through hole 31 near the other end (the upper-side end in FIG. 9).

As described above, the three mounting portions 30 are arranged such that adjacent mounting portions 30 are asymmetrically arranged in the Y-axis direction with two different distances therebetween. Similarly, the three mounting through holes 31 are arranged such that adjacent mounting through holes 30 are asymmetrically arranged in the Y-axis direction with two different distances therebetween. In this configuration, the relative position of the mounting portion 30 and the mounting through hole 30 in the Y-axis direction each of which is arranged near the center of the main body 27 changes depending on whether the lamp clip 18 is in the first orientation or the second orientation. The mounting portion 30 and the mounting through hole 31 near the center do not fit together when the clamp clip 18 is in the second orientation. Thus, the mounting through holes 30 cannot be passed through the mounting through holes 31.

As illustrated in FIG. 5, FIG. 6, and FIG. 9, the width (the dimension in the X-axis direction) of the main body 27 is smaller than the maximum outer diameter of the mounting through hole 31 (the total of the diameters of the large diameter portion 31a, the small diameter portion 31b, and the length of the connecting portion 31c). The main body 27 cannot cover the entire of each mounting through hole 31 when the lamp clip 18 is mounted. To cover each mounting through hole 31 in the present embodiment, three extended portions 37 are provided so as to extend from parts of the main body 27. The extended portions 37 are arranged on a rear side of the main body 27 so as to correspond to the mounting portions 30 in the Y-axis direction. The extended portions 37 each have a plate shape and extend to the rear side, i.e., in the direction opposite to the sliding direction for mounting. The length of each of the extended portions 37 extending from the main body 27 (the dimension in the X-axis direction) is at least larger than the difference between the width of the main body 27 and the maximum outer diameter of the mounting through hole 31. The length of each of the extended portions 37 extending from the main body 27 is substantially equal to or larger than the sliding distance at the time of mounting or detaching of the lamp clip 18. The width (the dimension in the Y-axis direction) of the extended portions 37 is larger than the diameter of the large diameter portion 31a of the mounting through hole 31. All of the extended potions 37 have the same width. With this configuration, the mounting through holes 31 are entirely closed with the main body 27 and the extended portions 37 when the lamp clip 18 is mounted. All of the extended portions 37 have the same length.

The present embodiment is characterized by the arrangement of each lamp clip 18 in the chassis 14 which will be described below. As illustrated in FIG. 7, the bottom plate 14a of the chassis 14, which is a mounting area of the lamp clips 18, is divided into a first area A1 and a second area A2 by a reference line L extending along the long-side direction (the X-axis direction) and passing through the center of the bottom plate 14a. The lamp clips 18 are arranged on the bottom plate 14a such that a distance between the reference line L and each support pin 29 is smaller than a distance between the reference line L and the center point BC of each main body 27. In addition, the lamp clips 18 are arranged such that the lamp clips 18 in the first area A1 and the lamp clips 18 in the second area A2, which is adjacent to the first area A1 with the reference line L therebetween, are slid in opposite directions for mounting. In the present embodiment, the area upper than the reference line L in FIG. 7 and FIG. 8 is referred to as the first area A1 and the area lower than the reference line L in FIG. 7 and FIG. 8 is referred to as the second area A2. Further, the reference line L extends along the long-side direction (the X-axis direction) of the diffuser plate 15a and the optical sheet 15b as the optical member and passes through the center thereof.

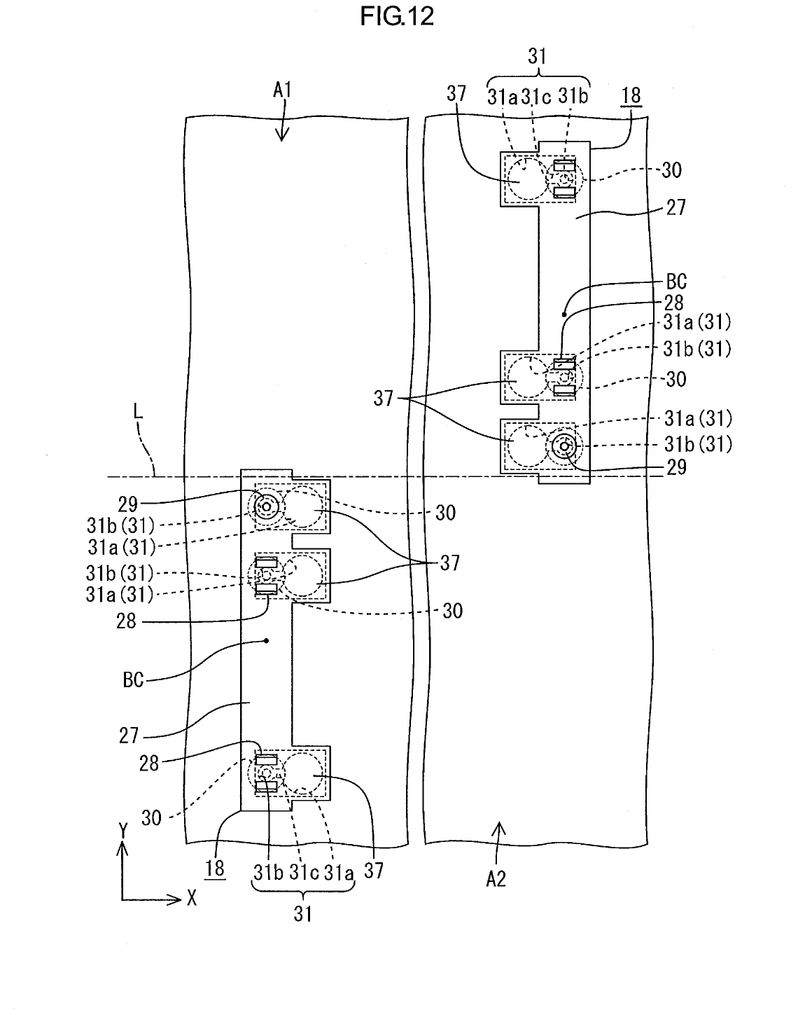

The lamp clips 18 in the first area A1 are mounted on the bottom plate 14a of the chassis 14 as illustrated in FIG. 7 and FIG. 12. Specifically, the lamp clip 18 is arranged in the first area A1 such that the support pin 29 on the main body 27 is located at the lower side in FIG. 7 and FIG. 12 and the lamp clip 18 is arranged in the second area A2 such that the support pin 29 on the main body 27 is located at the upper side in FIG. 7 and FIG. 12. In other words, each lamp clip 18 is mounted on the bottom plate 14a such that the other end of the main body 27 on which the support pin 29 is provided is located close to the reference line L and the one end of the main body 27 on which the lamp gripping portion 28 is provided is located away from the reference line L. With this arrangement, all of the support pins 29 that are located at the positions away from the center of the main bodies 27 in the Y-axis direction are arranged at the positions closer to the reference line L. Accordingly, the support pin 29 supports the diffuser plate 15a at the positions close to the center in the short-side direction (the Y-axis direction) of the diffuser plate 15a compared with the case in which each support pin 29 is arranged on a middle portion of the main body 27. That is, the distribution density of the support pins 29 is high in the middle portion in the short-side direction of the diffuser plate 15a. For example, if the diffuser plate 15s is subjected to a thermal expansion or a thermal contraction, the diffuser plate 15a may be easily warped or distorted to the cold cathode fluorescent tube 17 side at the middle potion of the screen because of its structure. However, in the present invention, the support pins 29 are distributed in high density on the middle potion of the screen, and thus, the warp or distortion is less likely to occur. The cold cathode fluorescent tubes 17 may be supported by the lamp clips 18 in the optimum number (the smaller number) and the optimum arrangement. When the lamp clips 18 are arranged in the optimum arrangement, the lamp clips 18 each having the support pin 29 at the position away from the center of the main body 27 are arranged such that the support pins 29 are close to the reference line L1, and thus, the warp or distortion of the diffuser plate 15a is less likely to occur.

Each lamp clip 18 mounted in the first area A1 (each lamp clip 18 in the first orientation) includes the extended portion 37 on the left side of the main body 27 in FIG. 7 and FIG. 12. Each lamp clip 18 mounted in the second area A2 (each lamp clip 18 in the first orientation) includes the extended portion 37 on the right side of the main body 27 in FIG. 7 and FIG. 12. As above, the lamp clips 18 in the first area A1 are mounted in the chassis 14 such that the orientation thereof is 180 degrees turned around to be opposite to the orientation of the lamp clips 18 in the second area A2. The lamp clips 18 having the same configuration are used in the first area A1 and the second area A2. That is, one kind of lamp clip 18 is used in the backlight unit 12. In other words, with the configuration in which the orientation of the lamp clip 18 is different in the first area A1 and the second area A2 adjacent to each other with the reference line L therebetween, the lamp clip 18 having the same configuration can be used for the both areas. In addition, the support pin 29 of each lamp clip 18 can be arranged close to the reference line L in the first and second areas A1, A2. Further, only one kind of lamp clip 18 is employed, and thus, the production cost and the management cost can be reduced resulting in the reduction in the production cost of the backlight unit 12. The support pin 29 of each lamp clip 18 is arranged at the closest position to the reference line L among the support pin 29 and the two lamp gripping portions 28. Conversely, the lamp gripping portion 28 on the one side is arranged at the furthest position from the reference line L among the support pin 29 and the two lamp gripping portions 28.

The distance between the reference line L and the support pin 29 of some of the lamp clips 18 in the first A1 is substantially the same as the distance between the reference line L and the support pin 29 of some of the lamp clips 18 in the second area A2. Specifically, three lamp clips 18 are arranged on three lines extending along the X-axis direction in each of the first and second areas A1, A2 of the chassis 14. A distance between the reference line L and each lamp clip 18 on the line closest to the reference line L in the first area A1 is substantially the same as a distance between the reference line L and each lamp clip 18 on the line closest to the reference line L in the second area A2. In the first and second areas A1, A2, the same positional relation can be applied to each lamp clip 18 on the second closest line from the reference line L and each lamp clip 18 on the farthest line from the reference line L, and the positional relation will not be explained. The three lamp clips 18 arranged along the X-axis direction are located on six lines arranged along the Y-axis direction, while each lamp clip 18 on each line is spaced part from the reference line L with three different distances therebetween, which is half the total number of lines. Further, the lamp clips 18 are substantially symmetrically arranged in each of the first area A1 and the second area A2 with respect to the center point SC of the bottom plate 14a of the chassis 14.

The arrangement of the mounting through holes 31 provided for mounting the lamp clips 18 arranged in the above manner will be described in detail. As illustrated in FIG. 8 and FIG. 12, sets of three mounting through holes 31 are provided on positions where the lamp clips 18 will be mounted. The distance between the closest one of the three mounting through holes 31 to the reference line L and the second closest one of the three mounting through holes 31 to the reference line L in the Y-axis direction is relatively small. The distance between the second closest one of the three mounting through holes 31 to the reference line L and the farthest one of the three mounting through holes 31 to the reference line L in the Y-axis direction is relatively large. The arrangement of the sets of the three mounting through holes 31 in the first area A1 is the same as that of the sets of the three mounting through holes 31 in the second area A2. Accordingly, at the time of mounting of the lamp clips 18 in the first area A1, the mounting portions 30 can fit together with the mounting through holes 31 only when the two mounting portions 30 arranged with the relatively small distance therebetween in the Y-axis direction are arranged near the reference line L, that is, only when the support pin 20 is arranged near the reference line L. The mounting through holes 31 in the first and second areas A1, A2 are substantially symmetrically arranged with respect to the center point SC of the bottom plate 14a of the chassis 14.

The mounting through holes 31 are arranged such that the large diameter portions 31a and the small diameter portions 31b are oppositely arranged in the first area A1 and the second area A2. Specifically, the mounting through holes 31 in the first area A1 each include the large diameter portion 31a, the connecting portion 31c, and the small diameter portion 31b in this sequence from the left side in FIG. 8 and FIG. 11, while the mounting through holes 31 in the second area A2 each include the large diameter portion 31a, the connecting portion 31c, and the small diameter portion 13b in this sequence from the right side in FIG. 8 and FIG. 11. The direction in which each lamp clip 18 is slid for mounting in the chassis 14 (moving direction) corresponds to the direction from the large diameter portion 31a to the small diameter portion 31b. Namely, the lamp clips 18 are slid in a direction indicated by an arrow X1 in FIG. 11 (to the right side in FIG. 11) to be mounted in the first area A1 and the lamp clips 18 is slid in a direction indicated by an arrow X2 in FIG. 11 (to the left side in FIG. 11) i.e., in a direction opposite to the direction indicated by the arrow X1, to be mounted in the second area A2. The lamp clips 18 are slid in opposite directions in the first area A1 and the second area A2 to be detached from the chassis 14.

The present embodiment has the above-described structure, and an operation thereof will be described. The liquid crystal panel 11 and the backlight unit 12 are separately produced and assembled using the bezel 13 or the like into the liquid crystal display device 10 illustrated in FIG. 3 and FIG. 4. Then, an assembling operation of the backlight unit 12, particularly, the mounting operation of the lamp clip 18 in the chassis 14 will be described in detail.

The reflection sheet 23 is provided on the inner side of the chassis 14 such that the insertion holes 32 of the reflection sheet 23 correspond to the mounting through holes 31 of the chassis 14. Then, the lamp clips 18 are mounted in the chassis 14. As illustrated in FIG. 7 and FIG. 8, preferably, this mounting operation for the first area A1 and the mounting operation for the second area A2 are performed separately by separate operators. Specifically, one operator on one side of the chassis 14 in the Y-axis direction performs the mounting operation for the first area A1 and one operator on the other side of the chassis 14 in the Y-axis direction performs the mounting operation in the second area A2. This reduces the misunderstanding of the operators about the operation method, because the same instructions can be given to the operators. Examples of the instructions include “mount the lamp clips 18 in the chassis 14 with the support pin 29 located farthest from you” and “slide the lamp clips 18 to the left to be mounted in the chassis 14.” This facilitates the mounting operation of the lamp clips 18. Particularly, this significantly facilitates the mounting operation of the lamp clips 18 in the large-size liquid crystal display device 10, because the large-size liquid crystal display device 10 includes the chassis 14 having a large short-side dimension which involves a difficulty for an operator to mount all lamp clips 18 from one side in the short-side direction. This advantage can also be obtained when the lamp clips 18 are detached from the chassis 14.

To mount the lamp clip 18 in the chassis 14, an operator grasps the support pin 29 and positions the main body 27 such that the long-side direction thereof corresponds to the short-side direction of the chassis 14. Then, the operator passes the mounting portions 30 through the mounting through holes 31 of the chassis 14. At this time, the lamp clip 18 may be in any one of two different orientations, a first orientation and a second orientation. In the first orientation, the extended portions 37 of the lamp clip 18 are oriented to the rear side. In the second orientation, the extended portions 37 are turned 180 degrees around the center point BC of the main body 27 from the first orientation and oriented to the front side. However, in the present embodiment, the lamp clip 18 can be mounted only when the mounting portions 30 and the mounting through holes 31 are in the first orientation. The lamp clip 18 in the first orientation will be described first.

The mounting portion 30 can correspond to the mounting through hole 31 when the lamp clip 18 is in the first orientation. As illustrated in FIG. 11, by pressing the lamp clip 18 in this orientation into the chassis 14, the protrusions 30b of the mounting portions 30 are passed through the respective large diameter portions 31a of the mounting through holes 31. At this time, the mounting portions 30 are concentric with the large diameter portions 31a of the corresponding mounting through holes 31. The support pin 29 to be manipulated by an operator is concentric with the mounting portion 30 on the other end portion in a plan view. This highly facilitates this operation. At this time, the entire of the large diameter portion 31a is overlapped with the main body 27, but the small diameter portion 31b is exposed.

Then, when the protrusions 30b of the mounting portions 30 are stuck out from the rear side of the chassis 14 after being passed through the insertion holes 32 and the mounting through holes 31, the lamp clip 18 is slid to the front side along the X-axis direction. The lamp clips 18 to be mounted in the first area A1 are slid in the direction indicated by the arrow X1 (to the right side) in FIG. 11 and the lamp clips 18 to be mounted in the second area A2 are slid in the direction indicated by the arrow X2 (to the left side) in FIG. 11. Then, the base portions 30a enter into the small diameter portions 31b from the large diameter portions 31a through the connecting portions 31c, and the protrusions 30b face the rear side of the edges of the mounting through holes 31 of the chassis 14. When the lamp clip 18 is moved to a predetermined position, as illustrated in FIG. 12, the mounting portions 30 are concentric with the small diameter portions 31b. At this time, as illustrated in FIG. 10, the edges of the mounting through holes 31 (especially, edges of the small diameter portions 31b and the connecting portions 31c) are sandwiched between the protrusions 30b of the mounting portions 30 and the main body 27. Accordingly, the mounting state of the lamp clip 18 with respect to the chassis 14 and the reflection sheet 23 can be maintained. As illustrated in FIG. 12, in this mounting state, the entire of each of the mounting through holes 31 and the insertion holes 32 is closed with the main body 27 and the extended portions 37 of the lamp clip 18, and not opened (or exposed) to the inside of the chassis 14. Further, the protrusions 30 sandwiching the edges of the mounting through holes 31 each have a flange-like shape, and thus, in the mounting state, sufficient amount of area is sandwiched to obtain high holding power.

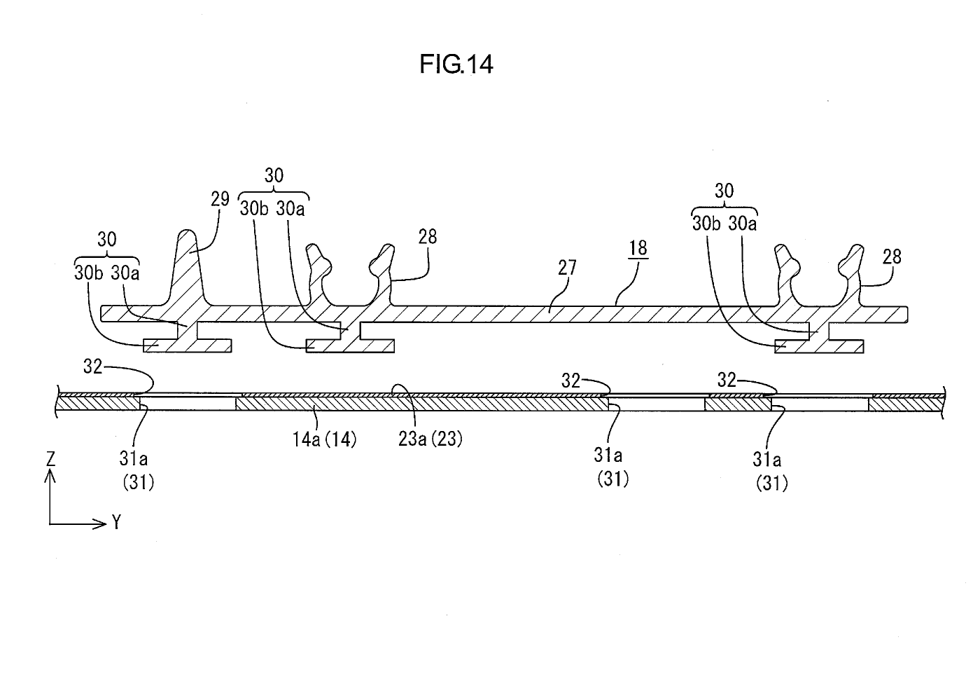

Next, the lamp clips 18 in the second orientation in which the lamp clip 18 is in the orientation opposite to the first orientation in a front to back direction will be explained. FIG. 13 illustrates the lamp clip 18 in the second orientation in the second area A2. As illustrated in FIG. 13, when an operator tries to mount the lamp clip 18 in the second orientation such that the mounting portions 30 correspond to the mounting through holes 31 in the Y-axis direction, the mounting portions 30 at each end can correspond to the corresponding mounting through holes 31, but the mounting portion 30 at a middle cannot correspond to the mounting through hole 32 at the middle in the Y-axis direction. As illustrated in FIG. 13 and FIG. 14, the protrusion 30 at the middle interferes with the bottom plate 14a of the chassis 14. Thus, the lamp clip 18 in the second orientation cannot be mounted in the chassis 14. In such a case, an operator should set the lamp clip 18 in the first orientation and begin the mounting operation again.

A problem may occur if the lamp clip 18 in the second orientation is allowed to be mounted. Such a problem will be explained with reference to FIG. 13. If the mounting portions 30 of the lamp clip 18 in the second orientation are passed through the mounting through holes 31 and slid toward the front side, the large diameter portions 31a of the mounting through holes 31 are not covered with the main body 27 or the extended portions 37, and thus the large diameter portions 31a may be exposed to the inside of the chassis 14. If the liquid crystal display device 10 is assembled with the lamp clip 18 mounted in this way and the cold cathode fluorescent tube 17 is lit to display an image on the liquid crystal panel 11, the exposed parts of the large diameter portions 31a of the mounting through holes 31 may be recognized as dark portions, or the light may leak through the exposed parts of the large diameter portions 31a of the mounting through holes 31 to the rear side of the chassis 14. According to the present embodiment, the lamp clip 18 cannot be mistakenly mounted in the second orientation in which the lamp clip 18 does not cover the mounting through holes 31, but always mounted in the first orientation in which the lamp clip 18 properly covers all of the mounting through holes 31. Thus, the dark portion does not appear on the liquid crystal panel 11 and the leakage of light does not occur.

After the lamp clips 18 are mounted in the chassis in the first orientation as above, the cold cathode fluorescent tubes 17 are housed in the chassis 14 so as to be held by the lamp gripping portions 28. Even if the lamp clip 18 is slid too much or too less for mounting in the chassis 14, the positions of the lamp gripping portions 28 in the Y-axis direction are not changed, because the sliding direction of the lamp clip 18 corresponds to the X-axis direction, i.e., the axial direction of the cold cathode fluorescent tube 17. If the cold cathode fluorescent tube 17 is attached to the lamp gripping portion of the lamp clip that is away from the predetermined position in the Y-axis direction, excessive force may act on the cold cathode fluorescent tube 17 and the glass tube may be broken in some cases. However, in the present embodiment, even if the cold cathode fluorescent tube 17 is attempted to be attached to the lamp gripping portion 28 of the lamp clip 18 that is away from the predetermined position, the excessive force will not act on the cold cathode fluorescent tube 17, and the cold cathode fluorescent tube 17 can be stably held. After all the cold cathode fluorescent tubes 17 are attached, the holder 20 is attached. Then, the diffuser plate 15a and the optical sheets 15b are laminated to assemble the backlight unit 12, and the liquid crystal panel 11 is arranged on the front side of the backlight unit 12. Then, the bezel 13 is attached. Consequently, the liquid crystal display device 10 illustrated in FIG. 3 and FIG. 4 is assembled.

As illustrated in FIG. 10, when the diffuser plate 15a and the optical sheet 15b as the optical members are mounted to the chassis 14, the diffuser plate 15a arranged on the rear side is supported by the support pin 29 included in each lamp clip 18. This enables the positional relation between the diffuser plate 15a and the cold cathode fluorescent tube 17 in the Z-axis direction to be stably maintained. The diffuser plate 15a and the optical sheet 15b may be thermally expanded or thermally contracted according to the change in the temperature in the backlight unit 12 caused by turning on or off of the cold cathode fluorescent tube 17. Generally, warp and distortion caused by the thermal expansion or the thermal contraction may readily occur on the middle portion of the diffuser plate 15a and the optical sheet 15b. However, as illustrated in FIG. 7, the lamp clips 18 according to the present embodiment are arranged such that the distance between the support pin 29 and the reference line L is smaller than the distance between the center point BC of the main body 27 and the reference line L. Namely, the distribution density of the support pins 29 on the diffuser plate 15a is higher around the reference line L, that is, in the middle portion in the short-side (the Y-axis direction). The middle portion of the diffuser plate 15a in which the warp or distortion easily occur can be properly supported by the support pings 29. With this configuration, warp or distortion due to the thermal expansion or the thermal contraction is less likely to occur on the diffuser plate 15a directly supported by the support pin 29 and the optical sheet 15b indirectly supported by the support pin 29 through the diffuser plate 15a. The uneven brightness is less likely to occur in the light exiting from the backlight unit 12 through the diffuser plate 15a and the optical sheet 15b.

As described above, the backlight unit 12 according to the present embodiment includes the chassis 14 including the mounting through holes 31, the cold cathode fluorescent tube 17 as the linear light source housed in the chassis 14, the diffuser plate 15a as the optical member arranged at the light exiting side of the cold cathode fluorescent tube 17, the lamp clips 18 configured to be slid along an axial direction of the cold cathode fluorescent tube 17 when the light source holders 28 are mounted or detached with respect to the chassis 14. The lamp clips 18 each includes the main body 27 attached to the chassis 14, the lamp gripping portion 28 provided on the main body 27, the support pin 29 arranged away from the center of the main body 27, and the mounting portion 30 protruding from the main body 27 and configured to pass through corresponding one of the mounting through holes 31 of the chassis 14 such that an edge of the mounting through hole 31 is sandwiched between the mounting portion 30 and the main body 27. The lamp gripping portion 28 is configured to grip the cold cathode fluorescent tube 17. The support pin 29 is configured to support the diffuser plate 15a. The lamp clips 18 are each arranged such that a distance between the reference line L in the chassis 14 and the support pin 29 is smaller than a distance between the reference line L and the center of the main body 27. The reference line L is set to divide an arrangement area of the lamp clips 18 in the chassis 14 into the first area A1 and the second area A2 adjacent to each other. The lamp clips 18 are each arranged in the first area A1 and the second area A2 so as to be slid in opposite directions with the mounting portion 30 passing through the mounting through hole 31 when each of the cold cathode fluorescent tube 17 is mounted in the chassis 14.

With this configuration, the cold cathode fluorescent tube 17 housed in the chassis 14 can be gripped by the lamp gripping portion 28 of the lamp clip 18 and the diffuser plate 15a arranged on the light exiting side of the cold cathode fluorescent tube 17 can be supported by the support pin 29 of the lamp clip 18. In this configuration, the lamp clips 18 attached to the chassis 14 are arranged such that the distance between the reference line L, which is set to divide the arrangement area of the lamp clips 18 in the chassis 14, and the support pin 29, which is arranged to be away from the center of the main body 27, is smaller than the distance between the reference line L and the center of the main body 27. Accordingly, a distribution density of the support pins 29 with respect to the inner surface of the diffuser plate 15a is higher at the area closer to the reference line L. By setting the reference line L at a position where warp and distortion of the diffuser plate 15a is highly likely to occur, the support pins 29 can properly support the diffuser plate 15a so that the warp and distortion is less likely to occur. Thus, the unevenness brightness is less likely to occur in the light exiting from the backlight unit 12.

Further, in the present embodiment, the lamp clips 18 are configured to be slid along the axial direction of the cold cathode fluorescent tube 17 when the lamp clips 18 are mounted or detached with respect to the chassis 14. With this configuration, even if the lamp clip 18 is slid too much or too less for mounting, the positional relation between the lamp gripping portion 28 and the cold cathode fluorescent tube 17 in a direction intersecting with the axial direction of the cold cathode fluorescent tube 17 is less likely to be changed. Accordingly, the excessive force is less likely to act on the cold cathode fluorescent tube 17 when the cold cathode fluorescent tube 17 is gripped by the lamp gripping portion 28, and thus, the cold cathode fluorescent tube 17 can be stably held. In addition, the lamp clips 18 are arranged such that the lamp clips 18 in the first area A1 and the lamp clips 18 in the second area A2 are slid in opposite directions when the lamp clips 18 are mounted in the chassis 14. This allows the lamp clips 18 with the same configuration each including the support pin 29 at the position away from the center of the main body 27 to be mounted in the both areas adjacent to each other with the reference line therebetween. Accordingly, the number of kinds of the lamp clip 18 can be reduced, resulting in the reduction in cost. In addition to this, for example, in the mounting operation of the light source holders in the chassis, the mounting operation for the first area A1 and the mounting operation for the second area A2 can be performed by separate operators, and thus the operating instructions can be the same for the operators for the first and the second areas A1, A2. This facilitates the mounting operation.

The reference line L extends through the center of the diffuser plate 15a. With this configuration, the distribution density of the support pins 29 of the lamp clips 18 with respect to the inner surface of the diffuser plate 15a is higher at the area closer to the reference line L. Thus, the middle portion of the diffuser plate 15a where the warp or distortion is highly likely to occur due to its structure can be properly supported by the support pins 29.

The diffuser plate 15a has an elongated shape and the reference line L extends along a long-side direction of the diffuser plate 15a. In this configuration, the support pins 29 included in the lamp clips 18 are arranged such that the distribution density with respect to the inner surface of the diffuser plate 15a is higher at the area closer to the reference line L. Thus, the support pins 29 can properly support the diffuser plate 15a along the long-side direction thereof.

The lamp clips 18 are each arranged such that the support pin 29 is closer to the reference line L than the lamp gripping portion 28 is. With this configuration, the diffuser plate 15a can be supported by the support pin 29 that is arranged closer to the reference line L than the lamp gripping portion 28 and the cold cathode fluorescent tube 17 gripped by the lamp gripping portion 28. Thus, the warp or distortion of the diffuser plate 15a is less likely to occur.

The support pin 29 is arranged on the end portion of the main body 27 that is close to the reference line. With this configuration, the diffuser plate 15a can be supported by the support pin 29 that is arranged closest to the reference line L on the lamp clip 18. Thus, the warp or distortion of the diffuser plate 15a is less likely to occur.

The distance between the reference line L and the support pin 29 of at least one of the lamp clips 18 in the first area A1 is substantially equal to the distance between the reference line L and the support pin 29 of at least one of the lamp clips 18 in the second area A2. With this configuration, the diffuser plate 15a can be properly supported by the support pins 29.

Each of the mounting through holes 31 includes a large diameter portion 31a having a relatively large diameter, a small diameter portion 31b having a smaller diameter than the large diameter portion 31a, and a connecting portion 31c that connects the large diameter portion 31a and the small diameter portion 31b. An edge of the small diameter portion 31b is sandwiched between the mounting portion 30 and the main body 27. In this configuration, when the lamp clip 18 is slid with the mounting portion 30 being passed into the large diameter portion 31a of the mounting through hole 31, the mounting portion 30 is moved into the small diameter portions 31b through the connecting portion 31c and the edge of each of the small diameter portions 31b is sandwiched between the mounting portion 30 and the main body 27. Accordingly, the lamp clip 18 can be stably mounted in the chassis 14.

The mounting through holes 31 are each arranged such that an arrangement order of the large diameter portion 31a and the small diameter portion 31b in the first area A1 is reversed in the second area A2. With this configuration, the lamp clips 18 in adjacent areas A1, A2 with the reference line L therebetween can be slid in opposite directions when the lamp clips 18 are mounted in the chassis 14.

The lamp clips 18 each further include the extended portion 37 extending from the main body 27 in a direction opposite to a sliding direction in which the lamp clip 18 is slid for mounting. A part of the extended portion 37 overlaps with the large diameter portion 31a in a plan view with the mounting portion 30 being in the small diameter portion 31b. In this configuration, when the lamp clip 18 is slid after the mounting portion 30 is passed through the large diameter portion 31a of the mounting through hole 31, the mounting portion 30 enters the small diameter portion 31b and the edge of the small diameter portion 31b is sandwiched between the mounting portion 30 and the main body 27, and further at least a part of the extended portion 37 overlaps with the large diameter portion 31a in a plan view. By covering the large diameter portion 31a with the extended portion 37 as above, the large diameter portion 31a is not exposed. Further, the extended portion 37 only protrudes from parts of the main body 27, and thus the lamp clip 18 can have a small surface area compared with the lamp clip 18 including a main body 27 having a large width over the entire length thereof. Thus, the brightness unevenness is less likely to occur and a material cost can be reduced.

The extended potion 37 has a width larger than the diameter of the large diameter portion 31a. With this configuration, the extended portion 37 can cover the entire area of the large diameter portion 31a.

Each of the lamp clips 18 includes at least three mounting portions 30 and at least three mounting through holes 31. The at least three mounting portions 30 are aligned in the direction substantially perpendicular to the axial direction of the cold cathode fluorescent tube 17 with at least two different distances therebetween. Two of the three mounting portions 30 arranged to sandwich a rest one of the three mounting portions 30 are arranged asymmetrically with respect to the rest one of the three mounting portions 30. Further, the at least three mounting through holes 31 are aligned in the direction substantially perpendicular to the axial direction of the cold cathode fluorescent tube 17 with two different distances therebetween. Two of the three mounting through holes 31 arranged to sandwich a rest one of the three mounting through holes 31 are arranged asymmetrically with respect to the rest one of the three mounting through holes 31. In this configuration, if an operator tries to mount the lamp clip 18 in an orientation different from a predetermined orientation in the chassis 14, not all of the three mounting portions 30 asymmetrically aligned in the direction substantially perpendicular to the axial direction of the cold cathode fluorescent tube 17 with two different distances therebetween fit together with the corresponding mounting through holes 31. This does not allow the lamp clip 18 to be mounted, and then the operator realizes that the lamp clip 18 is not in the predetermined orientation. Then, the operator sets the lamp clip 18 in the predetermined orientation and begins the mounting operation again.

The at least three mounting portions 30 are arranged on the line extending in the direction perpendicular to the axial direction of the cold cathode fluorescent tube 17. Further, the at least three mounting through holes 31 are arranged on the line extending in the direction perpendicular to the axial direction of the cold cathode fluorescent tube 17. With this configuration, the size of the lamp clip 18 can be made smaller in the axial direction of the cold cathode fluorescent tube 17.

Two of the at least three mounting portions 30 arranged on each end portion of the main body 27 are arranged such that the distance between the center of the main body 27 and each of two of the at least three mounting portions 30 is substantially equal. The lamp clip 18 can be mounted when the edges of the mounting through holes 31 are sandwiched between the main body 27 and the mounting portions 30. Accordingly, with the above configuration, the lamp clip 18 can be stably mounted in the chassis 14.

The mounting portion 30 overlaps with the support pin 29 in a plan view. With this configuration, when the mounting portions 30 are passed into the corresponding mounting through holes 31, the support pin 29 that is arranged at the position overlapping with the one of the mounting portions 30 can be manipulated. Thus, this operation is facilitated.

The mounting portion 30 is concentric with the support pin 29. With this configuration, when the mounting portion is passed through the corresponding mounting through hole 31, the support pin 29 concentric with the mounting portion can be manipulated. Thus, this operation is facilitated.

The mounting portion 30 overlaps with the lamp gripping portion 28 in a plan view. With this configuration, the position of the lamp gripping portion 28 can be easily recognized by visually checking the mounting portion 30. Conversely, the position of the mounting portion 30 can be easily recognized by visually checking the lamp gripping portion 28.

The cold cathode fluorescent tube 17 includes a plurality of cold cathode fluorescent tubes 17. The cold cathode fluorescent tubes 17 are spaced apart from each other with axis lines thereof being parallel to each other. Further, the lamp gripping portion 28 and the support pin 29 are provided adjacent to each other on each of the lamp clips 18 with the distance smaller than the distance between the adjacent cold cathode fluorescent tubes 17. In this configuration, the support pin 29 can be located between the adjacent cold cathode fluorescent tubes 17. Compared with the case in which the distance between the lamp gripping portion 28 and the support pin 29 is larger than the distance between the adjacent cold cathode fluorescent tubes 17, the size of the lamp clip 18 can be made smaller in the direction in which the cold cathode fluorescent tubes 17 are arranged.

Each of the lamp clips 18 includes a plurality of lamp gripping portions 28. The lamp gripping portions 28 are adjacent to each other. Further, the support pin 29 is arranged adjacent to one of the lamp gripping portions 28. A distance between the support pin 29 and the lamp gripping portion 28 adjacent to the support pin 29 is smaller than a distance between the adjacent lamp gripping portions 28. In this configuration, the support pin 29 can be located between the adjacent cold cathode fluorescent tubes 17 gripped by the adjacent lamp gripping portions 28. Compared with the case in which the distance between the lamp gripping portion 28 and the support pin 29 is larger than the distance between the adjacent lamp gripping portions 28, the size of the lamp clip 18 can be made smaller in the direction in which the lamp gripping portions 28 are arranged.

The lamp gripping portions 28 of each lamp clips 18 are substantially aligned in the direction substantially perpendicular to the axial direction of the cold cathode fluorescent tube 17. With this configuration, the cold cathode fluorescent tubes 17 can be gripped by the lamp gripping portions 28 at substantially the same position in the axial direction of the cold cathode fluorescent tube 17. Thus, the cold cathode fluorescent tubes 17 can be stably held.

The support pin 29 and the lamp gripping portion 28 are substantially aligned in the direction substantially perpendicular to the axial direction of the cold cathode fluorescent tube 17. With this configuration, the size of the lamp clip 18 can be made smaller in the axial direction of the cold cathode fluorescent tube 17.

The distance between the center of the main body 27 and one of the lamp gripping portion 28 and the support pin 29 on one end portion of the main body 27 is substantially equal to the distance between the center of the main body 27 and one of the lamp gripping portion 28 and the support pin 29 on the other end of the main body 27. With this configuration, any of the lamp gripping portion 28 and the support pin 29 on each end portion of the main body 27 can properly perform its function.

The cold cathode fluorescent tube 17 includes a plurality of cold cathode fluorescent tubes 17. The cold cathode fluorescent tubes 17 are substantially equally spaced apart from each other with axis lines thereof being parallel to each other. With this configuration, uneven brightness is less likely to occur in the light exiting from the backlight unit 12.

The lamp clips 18 are arranged in the chassis 14 in a zigzag pattern. With this configuration, the lamp clip 18 arranged in the chassis 14 is less likely to be recognized as a dark portion, and thus brightness unevenness is less likely to occur.

The cold cathode fluorescent tube 17 is a cold cathode fluorescent tube. With this configuration, a service life of the light source can be longer and control of light can be easily performed.

### Other embodiments

The present invention is not limited to the embodiments explained in the above description with reference to the drawings. The following embodiments may be included in the technical scope of the present invention, for example.

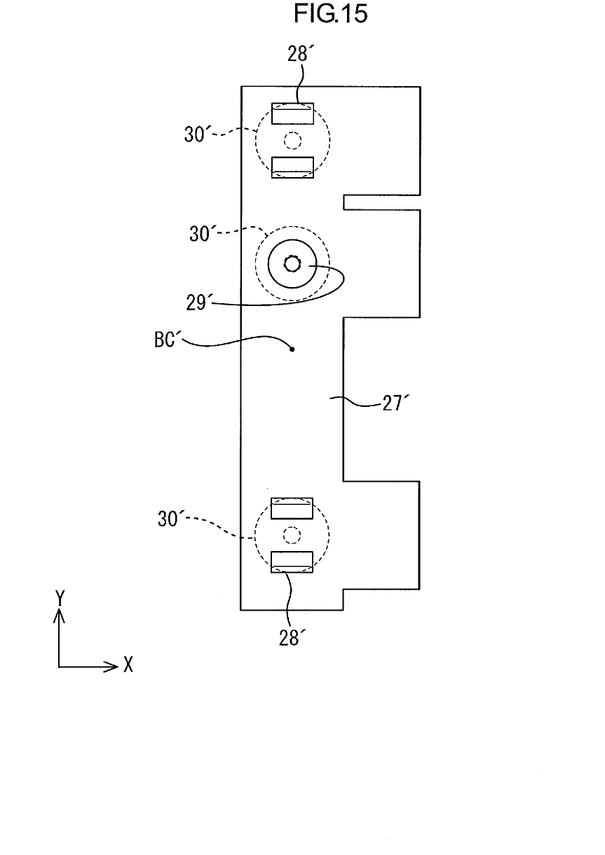

(1) The lamp gripping portions and the support pin may be arranged differently from the above embodiments. Specifically, as illustrated in FIG. 15, two lamp gripping portions 28′ may be arrange near each end portion of the main body 27′ and a support pin 29′ may be arrange near the center of the main body 27′. The support pin 29′ is positioned away from the center of the main body 27′ in the Y-axis direction. That is, the support pin 29′ is positioned near one of the lamp gripping portions 28′. This configuration is included in the present invention. In such a case, preferably, mounting portions 30′ overlap with the lamp gripping portions 28′ and the support pin 29′ in a plan view.

(2) In the above embodiments, the lamp clips 18 in the first area A1 are slid to the right side in FIG. 7 and the lamp clips 18 in the second area A2 are slid to the left side in FIG. 7. However, the lamp clips 18 may be configured so as to be slid in the opposite directions in each area A1, A2. In such a case, in each area, the arrangement order of the large diameter portion and the small diameter portion of each mounting through hole should be opposite to that in FIG. 8.

(3) As illustrated in FIG. 7 and FIG. 12, in the above embodiments, the reference line L overlaps with the main bodies 27 of the nearest lamp clips 18. However, the reference line L may not overlap with the nearest lamp clips 18.

(4) In the above embodiments, the reference line is set so as to extend along the long-side direction (the X-axis direction) of the chassis and the diffuser plate and pass through the center in the short-side direction. However, the position of the reference line may be suitably changed. For example, the reference line may extend through the position away from the center (the decentered position) in the short-side direction of the chassis and the diffuser plate.

(5) In addition to the above (4), the orientation of the reference line may be changed. For example, the reference line may be set so as to extend along the short-side direction of the chassis and the diffuser plate while the cold cathode fluorescent tube is arranged such that the axial direction thereof matches the short-side direction of the diffuser plate.

(6) In the above embodiments, the number of lines of the three lamp clips arranged in the X-axis direction is smaller than the number of distances between each lamp clip and the reference line. The ratio of the numbers may be other than the half. The numbers may be the same.

(7) In the above embodiments, the lamp clips in each area are symmetrically arranged with respect to the center point of the bottom plate of the chassis. However, the lamp clips may be asymmetrically arranged with respect to the center point of the bottom plate.

(8) In the above embodiments, the mounting portions are linearly arranged along the Y-axis direction and the mounting through holes are linearly arranged along the Y-axis direction along the Y-axis direction. However, the mounting portions may be arranged on two separate lines extending in the Y-axis direction and the mounting through holes may be arranged on two separate lines extending in the Y-axis direction

(9) In the above embodiments, the sets of three mounting portions and the sets of three mounting through holes are described as an example. However, the technology of the present invention is applicable to a lighting device including sets of four or more mounting portions and four or more mounting through holes. In such a case, adjacent lamp clips in the Y-axis direction may be spaced apart from each other with three or more different distances.

(10) In the above embodiments, the mounting portions are asymmetrically arranged and the mounting through holes are asymmetrically arranged. However, the mounting portions may be symmetrically arranged and the mounting through holes may be symmetrically arranged.

(11) In the above embodiments, the adjacent mounting portions are spaced apart from each other in the Y-axis direction with two different distances and the adjacent mounting through holes are spaced apart from each other in the Y-axis direction with two different distances. However, the mounting portions may be arranged in the Y-axis direction such that the adjacent mounting portions are equally spaced apart from each other with the same distance therebetween.

(12) In the above first to third embodiments, the large diameter portion and the small diameter potion of the mounting through hole are spaced apart from each other in the axial direction of the cold cathode fluorescent tube (the X-axis direction). In other words, the distance between the center of the large diameter potion and the center of the small diameter portion is larger than the total of the diameters of the large diameter portion and the small diameter portion. However, in the present intention, the positional relation between the large diameter portion and the small diameter portion in the axial direction of the cold cathode fluorescent tube may be suitably changed. For example, the distance between the center of the large diameter potion and the center of the small diameter portion may be substantially the same as or smaller than the total of the diameters of the large diameter portion and the small diameter portion. When the distance between the center of the large diameter potion and the center of the small diameter portion is smaller than the total diameters thereof, the large diameter portion and the small diameter portion partially overlap with each other in a plan view.

(13) In the above embodiments, the mounting portion overlaps with the lamp gripping portion in a plan view. However, the mounting portion may not overlap with the lamp gripping portion.

(14) In the above embodiments, the mounting portion overlaps and is concentric with the support pin in a plan view. However, the center of the mounting portion may not match with the center of the support pin while the mounting portion overlaps with the support pin in a plan view. Further, the mounting portion may not overlap with the support pin in a plan view.

(15) In the above embodiment, the number of mounting portions is equal to the total number of lamp gripping portions and support pins. However, the number of mounting portions may not be equal to the total number of lamp gripping portions and support pins. In such a case, the number of mounting portions may be either larger or smaller than the total number of lamp gripping portions and support pins.

(16) In the above embodiments, the lamp clip includes two lamp gripping portions. However, the number of lamp gripping portions may be one or three or more. Further, the number of support pins may be two or more.

(17) The number and arrangement of lamp clips mounted to the chassis may be properly changed from that of the above embodiments. Further, the number of cold cathode fluorescent tubes to be mounted in the chassis may be properly changed.

(18) The above embodiments employs the straight-type cold cathode fluorescent tube including an uncurved glass tube. However, the cold cathode fluorescent tube may include a glass tube extending in a U-shape or W-shape. In such a case, the lamp gripping portions included in one lamp clip may grip one cold cathode fluorescent tube.

(19) In the above embodiments, the cold cathode fluorescent tube is used as the linear light source. However, a different type of linear light sources such as a hot cathode tube may be used.

(20) In the above embodiments, the liquid crystal panel and the chassis are arranged in a vertical position such that the short-side direction matches the vertical direction. However, the liquid crystal panel and the chassis are arranged in a vertical position such that the long-side direction matches the vertical direction.

(21) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(22) In the above embodiments, the liquid crystal display device including the liquid crystal panel as a display panel is used. The technology can be applied to display devices including other types of display panels.

(23) In the above embodiments, the television receiver including the tuner is used. However, the technology can be applied to a display device without a tuner.

(24) In the above embodiments, the diffuser plate is exemplified as the optical member directly supported by the support pin. However, in the present invention, other optical members (for example, diffuser sheet) may be directly supported by the support pin. Further, the diffuser sheet, the lens sheet, and the reflection-type polarizing plate, which are all optical sheets, are exemplified as the optical member indirectly supported by the support pin. However, in the present invention, other optical sheets (for example, lenticular lens sheet) may be indirectly supported by the support pin. Further, the number of optical sheet may be properly changed.

### EXPLANATION OF SYMBOLS

10: liquid crystal display device (display device), 11: liquid crystal panel (display panel), 12: backlight unit (lighting device), 14: chassis, 15a: diffuser plate (optical member), 15b: optical sheet (optical member), 17: cold cathode fluorescent tube (linear light source), 18: lamp clip (light source holder), 27: main body, 28: lamp gripping portion (light source gripping portion), 29: support pin (supporting member), 30: mounting portion (mounting portion), 31: mounting through hole (mounting through hole), 31a: large diameter portion, 31b: small diameter portion, 31c: connecting portion, 37: extended portion, A1: first area (area), A2: second area (area), BC: center point (center), L: reference line, TV: television receiver

1. A lighting device comprising:
a chassis including mounting through holes;
a linear light source housed in the chassis;
an optical member arranged at a light exiting side of the linear light source;
a plurality of light source holders configured to be slid along an axial direction of the linear light source when the light source holders are mounted or detached with respect to the chassis, the light source holders each including:
a main body attached to the chassis;
a light source gripping portion provided on the main body, the light source gripping portion being configured to grip the linear light source;
a supporting member arranged to be away from a center of the main body, the supporting member being configured to support the optical member; and
a mounting portion protruding from the main body and configured to pass through corresponding one of the mounting through holes of the chassis such that an edge of the mounting through hole is sandwiched between the mounting portion and the main body, wherein:
the light source holders are each arranged such that a distance between a reference line in the chassis and the supporting member is smaller than a distance between the reference line and a center of the main body, the reference line being set to divide an arrangement area of the light source holders in the chassis into a first area and a second area adjacent to each other; and
the light source holders are each arranged in the first area and the second area so as to be slid in opposite directions when each of the light source holders is mounted in the chassis with the mounting portion passing through the mounting through hole.

2. The lighting device according to claim 1, wherein the reference line extends through a center of the optical member.

3. The lighting device according to claim 1, wherein:
the optical member has an elongated shape; and
the reference line extends along a long-side direction of the optical member.

4. The lighting device according to claim 1, wherein the light source holders are each arranged such that the supporting member is closer to the reference line than the light source gripping portion is.

5. The lighting device according to claim 4, wherein the supporting member is arranged on an end portion of the main body that is close to the reference line.

6. The lighting device according to claim 1, wherein a distance between the reference line and the supporting member of at least one of the light source holders in the first area is substantially equal to a distance between the reference line and the supporting member of at least one of the light source holders in the second area.

7. The lighting device according to claim 1, wherein each of the mounting through holes includes:
a large diameter portion having a relatively large diameter;
a small diameter portion having a smaller diameter than the large diameter portion; and
a connecting portion that connects the large diameter portion and the small diameter portion, and an edge of the small diameter portion is sandwiched between the mounting portion and the main body.

8. The lighting device according to claim 7, wherein the mounting through holes are each arranged such that an arrangement order of the large diameter portion and the small diameter portion in the first area is reversed in the second area.

9. The lighting device according to claim 7, wherein the light source holders each further include an extended portion extending from the main body in a direction opposite to a direction in which the light source holder is slid for mounting, a part of the extended portion overlapping with the large diameter portion in a plan view with the mounting portion being in the small diameter portion.

10. (canceled)

11. The lighting device according to claim 1, wherein:
each of the light source holders includes at least three mounting portions and at least three mounting through holes;
the at least three mounting portions are aligned in a direction substantially perpendicular to the axial direction of the linear light source with at least two different distances therebetween, and two of the three mounting portions arranged to sandwich a rest one of the three mounting portions are arranged asymmetrically with respect to the rest one of the three mounting portions; and
the at least three mounting through holes are aligned in the direction substantially perpendicular to the axial direction of the linear light source with two different distances therebetween, and two of the three mounting through holes arranged to sandwich a rest one of the three mounting through holes are arranged asymmetrically with respect to the rest one of the three mounting through holes.

12. The lighting device according to claim 11, wherein the at least three mounting portions are arranged on a line extending in the direction perpendicular to the axial direction of the linear light source; and
the at least three mounting through holes are arranged on the line extending in the direction perpendicular to the axial direction of the linear light source.

13. The lighting device according to claim 1, wherein two of the at least three mounting portions arranged on each end portion of the main body are arranged such that a distance between a center of the main body and each of two of the at least three mounting portions is substantially equal.

14. The lighting device according to claim 1, wherein the mounting portion overlaps with the supporting member in a plan view.

15. The lighting device according to claim 1, wherein the mounting portion is concentric with the supporting member.

16. The lighting device according to claim 1, wherein the mounting portion overlaps with the light source gripping portion in a plan view.

17. (canceled)

18. The lighting device according to claim 1, wherein:
each of the light source holders includes a plurality of light source gripping portions, the light source gripping portions being adjacent to each other; and
the supporting member is arranged adjacent to one of the light source gripping portions, a distance between the supporting member and the light source gripping portion adjacent to the supporting member is smaller than a distance between the adjacent light source gripping portions.

19. The lighting device according to claim 18, wherein the light source gripping portions of each light source holder are substantially aligned in the direction substantially perpendicular to the axial direction of the linear light source.

20. (canceled)

21. The lighting device according to claim 1, wherein a distance between a center of the main body and one of the light source gripping portion and the supporting member on one end portion of the main body is substantially equal to a distance between the center of the main body and one of the light source gripping portion and the supporting member on the other end of the main body.

22. (canceled)

23. (canceled)

24. (canceled)

25. A display device comprising:
a lighting device according to claim 1; and
a display panel configured to provide display using light from the lighting device.

26. The display device according to claim 25, wherein the display panel is a liquid crystal panel constructed such that a liquid crystal is sealed between a pair of glass substrates.

27. (canceled)
